(19) United States
(12) Patent Application Publication
(10) Pub. No.: US 2026/0303776 A1
(43) Pub. Date: Oct. 1, 2026

(54) DYNAMIC PARALLAX CORRECTION AND BINOCULAR ZOOM ALIGNMENT FOR TELEPHOTO CAMERAS IN XR DEVICES

(71) Applicant: Adeia Imaging LLC, San Jose, CA (US)

(72) Inventors: Charles Dasher, Lawrenceville, GA (US); Jean-Yves Couleaud, Mission Viejo, CA (US); Reda Harb, Saint Petersburg, FL (US); Ning Xu, Irvine, CA (US)

(21) Appl. No.: 19/091,445

(22) Filed: Mar. 26, 2025

(51) Int. Cl. H04N 13/398; G02B 13/02; H04N 13/344; H04N 13/361; H04N 23/69

(52) U.S. Cl. CPC H04N 13/398; G02B 13/02; H04N 13/344; H04N 13/361; H04N 23/69

(57) ABSTRACT

An extended reality (XR) apparatus is provided comprising a wide-angle camera, a telephoto camera and control circuitry, which may cause the wide-angle camera to capture a wide-angle view of an environment and determine a region of interest (ROI) in the wide-angle view, the ROI comprising an object. The control circuitry may cause the telephoto camera to capture a zoomed-in view of the ROI and to generate a disparity map based at least in part on a difference between a location of the object in the wide-angle view and a location of the object in the zoomed-in view. Based on the disparity map, the control circuitry may process the wide-angle view and the zoomed-in view to correlate the location of the object in the wide-angle view with the location of the object in the zoomed-in view and cause display of the processed zoomed-in view overlaid on the processed wide-angle view.

### BACKGROUND

The present disclosure relates to imaging systems for extended reality (XR) devices with wide-angle cameras and telephoto cameras, to provide an XR experience.

### SUMMARY

XR devices, such as mobile devices or head-mounted displays (HMDs) or any suitable devices, are increasingly incorporating both telephoto and wide-angle cameras to provide enhanced real-world observation capabilities in pass-through modes, such as for applications that benefit from detailed focus with broader spatial context, e.g., remote collaboration, object recognition, and digital binocular functionality. For example, a user, while wearing an XR HMD, relies on a camera with a wide field of view (FOV) to spatially orient themselves. That user may be interested in obtaining a magnified image of an object in the surrounding environment (e.g., object within the wide FOV) while maintaining spatial awareness of the environment.

However, the combination of telephoto and wide-angle cameras presents significant challenges in maintaining consistent depth perception, spatial alignment, and seamless transitions between perspectives. In telephoto views, parallax mismatches become particularly significant, as small alignment errors between left and right camera inputs are amplified under high magnification, resulting in depth distortions, visual discomfort, distorted depth cues, and a loss of stereoscopic accuracy. At the same time, wide-angle cameras provide broader contextual information, but integrating these views with telephoto inputs requires precise spatial and depth alignment. Misalignments between the perspectives can cause objects to appear disjointed or incorrectly positioned, especially during transitions between wide-angle and zoomed-in views. Furthermore, binocular misalignment caused by the differing magnified views of each eye exacerbates the difficulty of achieving proper depth perception and seamless integration of the two perspectives. High-magnification settings amplify these challenges, as even minor parallax or alignment errors in the telephoto view are magnified and can significantly disrupt the user experience. These problems are further complicated by motion-related instability, as user head movements dynamically misalign the combined camera views.

While some approaches address certain alignment or focus issues in XR systems, they fail to fully resolve the unique difficulties posed by binocular telephoto zoom configurations. For instance, such approaches might handle depth reprojection or single-lens adjustments but do not adequately mitigate the amplified parallax errors, depth perception, issues, and binocular misalignments inherent in stereoscopic telephoto setups. Additionally, prior approaches lack robust solutions for integrating wide-angle and telephoto views or stabilizing these combined perspectives during user motion. These shortcomings highlight the need for an innovative approach to help provide consistent depth perception, spatial alignment, and seamless transitions in XR devices leveraging both telephoto and wide-angle cameras.

In one approach, an array of cameras on a device may be used to detect and correct parallax in images; however, this approach relies on systems with two similar cameras of similar focal lengths to address stereoscopic alignment and does not solve the problem of maintaining depth consistency and spatial alignment when an optically zoomed image is combined with a wide-angle view in XR systems. The combination of telephoto and wide-angle cameras presents challenges in maintaining consistent depth perception, spatial alignment, and seamless transitions between perspectives. Accordingly, there exists a need for improved XR devices, systems, and methods to address these issues.

To help overcome these problems, systems, methods, and apparatuses are disclosed herein for providing an XR display with a wide-angle camera, and a telephoto camera. The systems, methods, and apparatuses described herein may comprise control circuitry configured to cause the wide-angle camera to capture a wide-angle view of an environment and determine a region of interest (ROI) in the wide-angle view, wherein the ROI comprises an object. The control circuitry may be further configured to cause the telephoto camera to capture a zoomed-in view of the ROI and generate a disparity map based at least in part on the difference between a location of the object in the wide-angle view and a location of the object in the zoomed-in view. Based at least in part on the disparity map, processing the wide-angle view and the zoomed-in view to correlate the location of the object in the wide-angle view with the location of the object in the zoomed-in view may cause the XR apparatus to display the processed zoomed-in view overlaid on the processed wide-angle view.

Such aspects enable providing an XR apparatus that is capable of dynamically and seamlessly integrating a telephoto zoomed-in view with a broader wide-angle context, while preserving accurate depth perception and spatial alignment. By correlating the location of the object in both the wide-angle and telephoto views, the system can offer enhanced situational awareness, improved binocular disparity correction, and real-time overlay of high-magnification details. Such aspects help alleviate challenges associated with parallax errors or misalignment, offering users a more immersive and precise augmented or mixed-reality experience, by integrating telephoto zoom functionality into stereoscopic systems, focusing on maintaining accurate depth perception and consistent binocular alignment in pass-through modes. The wide-angle inputs may be used to anchor the telephoto view within a broader spatial context. In some embodiments, a real-time parallax correction algorithm may be used to help achieve precise alignment of left and right telephoto images, dynamically compensating for interpupillary distance (IPD) and lens offsets.

The disclosed systems and methods may help address parallax errors, mechanical misalignments, and depth distortions that occur in high-magnification settings. In some embodiments, the disclosed systems and methods may provide magnification-aware disparity correction and predictive alignment adjustments, to help provide consistent depth perception and alignment in telephoto views, even during dynamic user interactions or rapid zoom transitions, and the system may incorporate dynamic depth alignment and high-magnification calibration, for maintaining binocular consistency under telephoto zoom conditions. In some embodiments, magnification-specific parallax adjustments may be employed, where disparity maps are scaled based at least in part on the zoom factor to detect and correct parallax mismatches with fine granularity at higher magnifications. Inputs from the wide-angle camera may be used to anchor the telephoto view within the spatial context of the broader scene, to help ensure that objects remain consistently positioned and aligned across both perspectives. In some embodiments, the system dynamically integrates disparity corrections with mechanical adjustments, e.g., actuators may be employed to provide for precise shifts in camera positions to address alignment deviations, while optical zoom mechanisms controlled by the image processing unit ensure that both telephoto cameras maintain synchronized magnification. In some embodiments, the optical zoom mechanism may be controlled independently. In some embodiments, the wide-angle input provides a fallback reference for spatial alignment, e.g., during transitions between wide-angle and telephoto views.

In some embodiments, by dynamically calibrating dual telephoto cameras, the system helps achieve stereoscopic consistency even under high magnification, addressing parallax mismatches and binocular misalignments that are otherwise amplified in these scenarios. The system may continuously align dual-camera inputs, using real-time parallax correction to preserve depth perception. Gaze-driven zoom synchronization may be used to adjust the telephoto cameras to center on the user's focus, while motion stabilization mechanisms may be employed to recalibrate alignment and the binocular view during user head movements, to help avoid, minimize, or reduce alignment disruptions. In some embodiments, the gaze-driven zoom synchronization drives pan/tilt/zoom of the telephoto camera. In some embodiments, the system integrates wide-angle and telephoto perspectives, allowing users to maintain awareness of their surroundings while focusing on distant objects, and smooth depth transitions further ensure that changes in zoom levels do not disrupt the visual experience. By integrating gaze tracking with dual-camera zoom controls, the system adjusts magnification and focal alignment to match the user's gaze point while preserving binocular consistency. In some embodiments, the system provides a multi-focal exploration feature to allow users to simultaneously observe a wide-angle view for contextual awareness and a telephoto zoom view for detailed focus on distant objects. Adaptive depth transitions help provide smooth and visually comfortable adjustments between different zoom levels, further enhancing the user experience, to address telephoto-specific challenges in binocular alignment and dynamic zooming within XR environments. In some embodiments, the disclosed techniques may improve upon parallax correction methods and address stereoscopic corrections under dynamic telephoto zoom, at least in part by enabling real-time recalibration specifically for binocular telephoto systems.

In some embodiments, the proposed apparatuses, systems, and techniques disclosed herein employ at least two telephoto cameras and at least one wide-angle camera. In some embodiments, the proposed apparatuses, systems, and techniques disclosed herein employ at least two telephoto cameras and at least two wide-angle cameras, e.g., in a zoom-capable XR apparatus. In some embodiments, an optical passthrough headset, e.g., augmented reality (AR), implementing the techniques described herein may utilize at least wide-angle camera and at least two telephoto-cameras, e.g., provided that the only pass-through features the headset displays are the zoomed in inserts.

In some embodiments, the control circuitry is further configured to process the zoomed-in view by adjusting a zoom level of the telephoto camera, wherein the disparity map is updated based at least in part on the adjusted zoom level. In some embodiments, the XR apparatus comprises a first telephoto camera and a second telephoto camera configured to capture a first zoomed-in view and a second zoomed-in view, respectively, and the control circuitry is configured to adjust the zoom level of the telephoto camera by equalizing an apparent size of the object in the first zoomed-in view and the second zoomed-in view and causing the apparent size to remain within a predefined range.

In some embodiments, the control circuitry is further configured to process the zoomed-in view by adjusting a position and/or a pan/tilt of the telephoto camera. In some embodiments, the control circuitry is further configured to process the zoomed-in view by recalibrating the telephoto camera based at least in part on a detected motion or a predicted motion of a user associated with the XR apparatus.

In some embodiments, the control circuitry is further configured to determine a change in the ROI to a new ROI, update the disparity map based at least in part on the new ROI, further process the zoomed-in view and the wide-angle view based at least in part on the updated disparity map, and cause display of the further processed zoomed-in view and the wide-angle view. In some embodiments, the control circuitry is further configured to determine the ROI by determining a gaze vector corresponding to a gaze of a user of the XR apparatus and by determining that the gaze vector intersects coordinates of the object.

In some embodiments, the control circuitry is further configured to determine that the object is in motion, predict a future path of the motion of the object, and cause the telephoto camera to capture the zoomed-view based at least in part on continuously tracking the object based at least in part on the predicted future path.

In some embodiments, the processed zoomed-in view is overlaid on the processed wide-angle view at a location corresponding to the ROI. In some embodiments, the processed zoomed-in view is overlaid on the processed wide-angle view at a location that is different from the ROI.

In some embodiments, the disparity map is a first disparity map, and the telephoto camera comprises a left telephoto camera, a right telephoto camera, and control circuitry. The control circuitry is further configured to generate a second disparity map based at least in part on zoomed-in views captured by the left telephoto camera and the right telephoto camera and update the first disparity map with the second disparity map.

In some embodiments, an inertial measurement unit (IMU) detects motion of the XR apparatus, and control circuitry may be configured to pause display of the zoomed-in view by detecting motion of the XR apparatus and based at least in part on determining that motion of the XR apparatus is above a threshold, pausing the display of the zoomed-in view.

In some embodiments, systems, methods, and apparatuses are disclosed herein for an XR display with a sensor, telephoto camera, and control circuitry. The control circuitry may be configured to determine, based on sensor data captured by the sensor, a distance between the XR apparatus and an object in an ROI and cause the telephoto camera to capture a zoomed-in view of the ROI at a zoom level. The control circuitry may detect whether a user of the XR apparatus is moving towards the object, adjust the zoom level based at least in part on the detecting, and cause display of the zoomed-in view at the adjusted zoom level.

In some embodiments, the sensor is a LiDAR sensor. In some embodiments, the control circuitry is further configured to determine that the user is moving towards the object and, based at least in part on determining that the user is moving towards the object, adjust the zoom level by zooming out with respect to the object.

In some embodiments, the control circuitry is further configured to determine that the user is moving away from the object and, based at least in part on determining that the user is moving away from the object, adjust the zoom level by zooming in on the object.

In some embodiments, the sensor is a first sensor, the XR apparatus further comprises a second sensor to measure a pace (e.g., speed, velocity, and/or rate of change of distance between the user and ROI) of the movement of the user, wherein the control circuitry is further configured to adjust the zoom level based at least in part on the measured pace of the movement of the user.

In some embodiments, the control circuitry is further configured to determine the pace of the movement of the user is below a threshold and based at least in part on the determining that the pace of the movement of the user is below the threshold, adjust the zoom level by zooming in on the object.

In some embodiments, the control circuitry is further configured to determine the ROI by collecting facial data of the user using an inward-facing infrared (IR) sensor and determining a gaze vector based at least in part on the collected facial data.

In some embodiments, the control circuitry is further configured to cause the telephoto camera to zoom by detecting, based at least in part on sensor data detected by the inward-facing IR sensors, a facial action, and based at least in part on detecting the facial action, cause the telephoto camera to zoom-in based at least in part on a direction of the gaze vector.

In some embodiments, the control circuitry is further configured to generate for display, on the display of the XR apparatus, a request to zoom-in based at least in part on a direction of the ROI.

In some embodiments, the control circuitry is further configured to adjust a view path of the telephoto camera, keeping the object within a FOV of the telephoto camera by receiving, by an IMU sensor, motion data of the XR apparatus causing a set of actuators to adjust the view path of the telephoto camera to remain in a direction of the object.

In some embodiments, the control circuitry is further configured to determine that the object has moved from a first location to a second location; and cause the object at the second location to remain within a field of view (FOV) of the telephoto camera by adjusting a capture angle of the telephoto camera, based at least in part on the second location.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts content provided via an XR device, in accordance with some embodiments of this disclosure.

FIG. 2 depicts an illustrative disparity heatmap that integrates both wide-angle and telephoto perspectives, in accordance with some embodiments of this disclosure.

FIG. 3 depicts an illustrative block diagram and process for dynamic parallax correction and binocular zoom alignment of telephoto cameras for an XR HMD, in accordance with some embodiments of this disclosure.

FIG. 4 is a sequence diagram of a process for dynamically adjusting the zoom levels of the dual telephoto cameras based on the user's gaze direction, in accordance with some embodiments of this disclosure.

FIG. 5 is a sequence diagram of a process for users to manually lock focus on a specific depth or zoom level while temporarily disabling gaze-or motion-based adjustments, in accordance with some embodiments of this disclosure.

FIG. 6 is a sequence diagram of process for dynamically stabilizing the binocular view of the dual telephoto cameras in response to user head movements and environmental changes, in accordance with some embodiments of this disclosure.

FIG. 7 is a sequence diagram of a process for adapting cameras to dynamic environments, in accordance with some embodiments of this disclosure.

FIGS. 8A-8C depict renderings of a unified display, in accordance with some embodiments of the disclosure.

FIG. 9 is a sequence diagram of a process for enabling multi-focal exploration by integrating wide-angle and telephoto perspectives, in accordance with some embodiments of this disclosure.

FIG. 10 is a sequence diagram of a process for implementing adaptive depth transitions between varying focal depths and magnification levels, in accordance with some embodiments of this disclosure.

FIG. 11 is a sequence diagram of a process for a motion-based fallback mechanism while using zoomed telephoto views, in accordance with some embodiments of this disclosure.

FIG. 12 depicts renderings of a unified display, in accordance with some embodiments of this disclosure.

FIG. 13 is a sequence diagram of a process for providing visual stabilization indicators within the viewport to inform the user of ongoing system adjustments, in accordance with some embodiments of this disclosure.

FIG. 14 is a sequence diagram of a process for allowing users to lock onto an object of interest using gestures, in accordance with some embodiments of this disclosure.

FIG. 15 depicts a rendering of what a user may view, in accordance with some embodiments of this disclosure.

FIG. 16 is a sequence diagram of a process for providing smart zoom suggestions based on gaze patterns and scene analysis, in accordance with some embodiments of this disclosure.

FIG. 17 is a sequence diagram of a process for predicting the path of a moving object, such as a drone or vehicle, and overlays a dynamic trajectory within the zoomed-in viewport, in accordance with some embodiments of this disclosure.

FIGS. 18A-18B depict an illustrative rendering of object tracking, in accordance with some embodiments of this disclosure.

FIG. 19 is a sequence diagram of a process for dynamically adjusting the zoom level of the telephoto camera based on the user's pace and movement direction relative to an object of interest, in accordance with some embodiments of this disclosure.

FIGS. 20-21 are block diagrams of an illustrative user equipment device and system, in accordance with some embodiments of this disclosure.

The figures herein depict various embodiments of the disclosure for purposes of illustration only. It will be appreciated that additional or alternative structures, assemblies, systems, and methods may be implemented within the principles set out by the present disclosure.

### DETAILED DESCRIPTION OF THE DRAWINGS

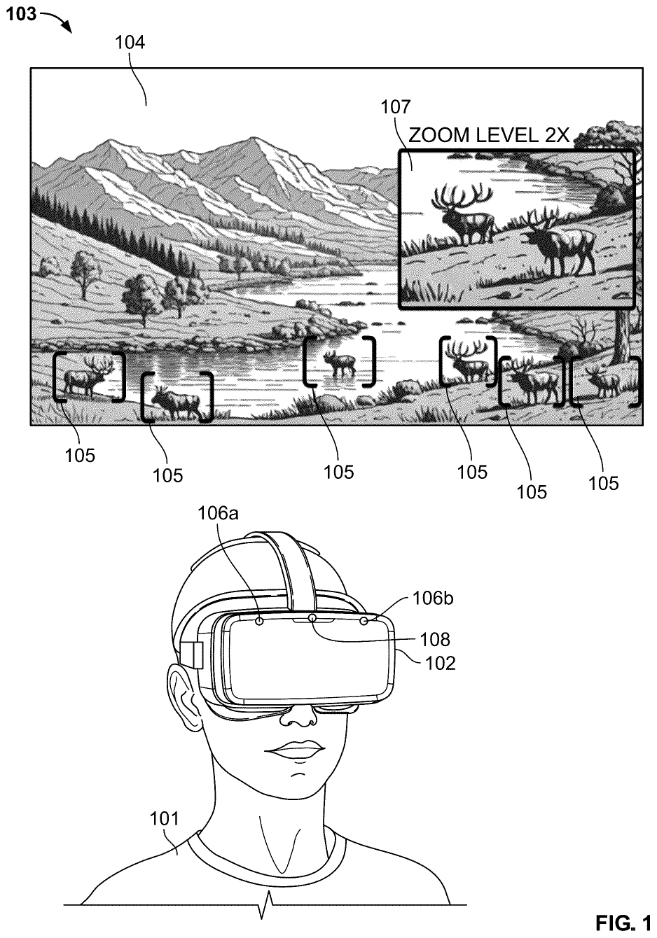

FIG. 1 depicts content provided via an XR device or apparatus, in accordance with some embodiments of this disclosure. As shown in FIG. 1, user 101 is wearing an XR device or apparatus 102 (e.g., an XR HMD 102). XR device 102 may be, for example, an XR HMD, XR glasses or goggles, a near-eye display device, a smartphone, a wearable device, a tablet, a laptop, any suitable XR device having multiple cameras and capable of simultaneously displaying video feeds (alone or in combination with another device), or any suitable combination thereof.

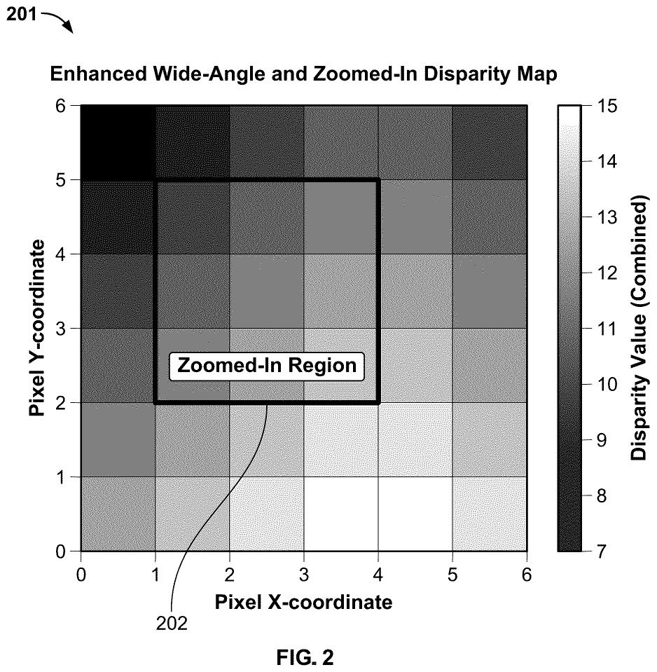

XR device 102 may comprise at least one telephoto camera 106a, 106b and at least one wide-angle camera 108. FIG. 1 includes an example of a scene displayed on the display 103 of the HMD. The scene comprises a wide-angle view 104 and a telephoto view 107, e.g., captured by wide-angle camera 108 and telephoto camera 106a, 106b, respectively. In some embodiments, objects in the scene may be detected, identified, and/or tracked at least in part with virtual frames (e.g., the plurality of moose highlighted by the virtual boxes 105). In some embodiments, the telephoto cameras 106a, 106b may be configured to zoom in on a detected object and generate for display a telephoto view (e.g., a telephoto view 107) overlapping or overlaid on (or otherwise simultaneously displayed with) the wide-angle view 104. In some embodiments, metadata (e.g., “Zoom level 2×”) associated with telephoto view 107 may be displayed adjacent to the telephoto view 107. In some embodiments, the combined display of wide-angle view 104 and telephoto view 107 may be generated at least in part by using a disparity map, discussed in more detail in relation to FIG. 2. For example, such disparity map may be used to process the wide-angle view and the zoomed-in view to correlate the location of the object in the wide-angle view with the location of the object in the zoomed-in view.

XR may be understood as virtual reality (VR), AR, or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such an environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world, or the real world is otherwise connected to virtual objects. In some embodiments, environment 100 may be a real-world environment, an AR environment (e.g., a real-world environment depicted as having virtual objects overlaid thereon), or a VR environment.

XR devices, as described herein, may comprise or correspond to user equipment configured to facilitate XR experiences, including AR, VR, and MR, and may include a variety of hardware and software components tailored to enhance real-world observation and digital interaction. Such devices may comprise HMDs equipped with stereoscopic displays for rendering immersive visuals, telephoto cameras (e.g., 106a, 106b) for capturing magnified views of distant objects, and wide-angle cameras (108) for providing broad spatial context, as utilized in pass-through modes for applications such as, for example, remote collaboration, digital binoculars, mixed-reality exploration, object recognition, and/or any other suitable application(s). Additionally, XR devices may incorporate gaze-tracking modules, employing infrared (IR) sensors to detect user eye movements and focal points, enabling dynamic adjustments to camera alignment and zoom based on the user's attention. Inertial measurement units (IMUs) may be configured to monitor linear acceleration and rotational velocity, supporting motion stabilization and predictive corrections during user head movements or environmental disturbances, such as, for example, those encountered in a moving vehicle.

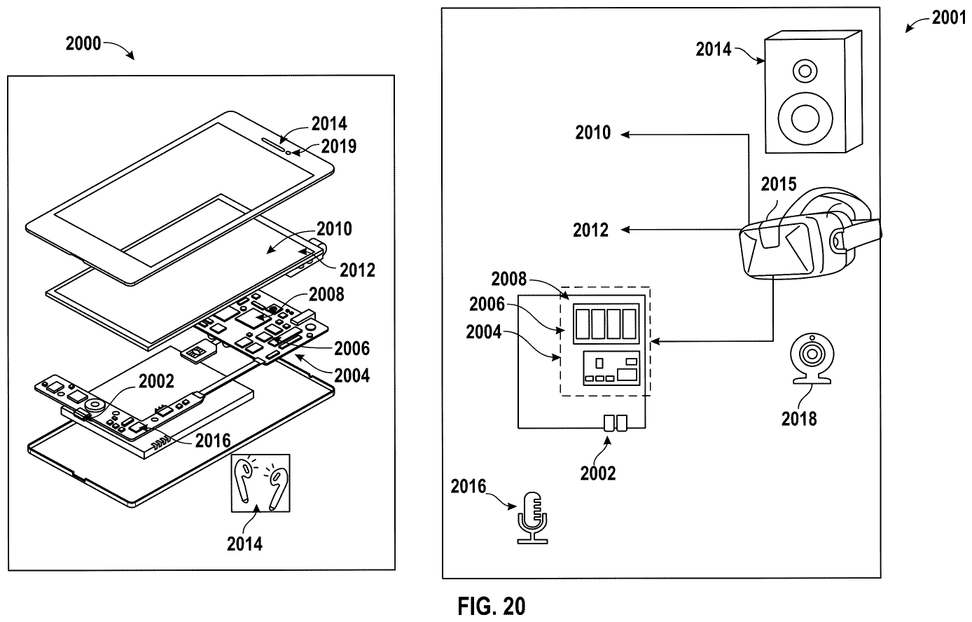

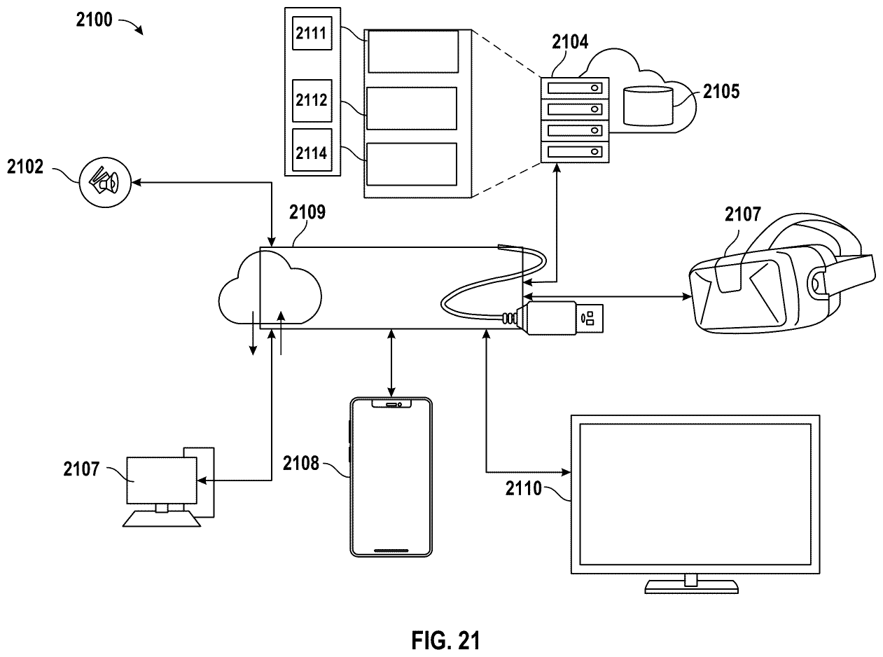

In some embodiments, XR devices comprise control circuitry—such as, for example, one or more microprocessors, graphics processing units (GPUs), and/or application-specific integrated circuits (ASICs), field-programmable gate arrays (FPGA), and/or any other suitable processor—coupled with storage components (e.g., random access memory (RAM), flash memory, cloud-based repositories, and/or any other suitable computer memory or storage) to process and retain calibration data, disparity maps, and user interaction profiles for seamless multi-focal exploration between wide-angle and telephoto perspectives. Such control circuitry included in the XR device is explained in more detail in the description of FIGS. 20-21. Some other examples of XR devices may be, for example, mobile devices, e.g., smartphones or tablets, configured with suitable XR applications and camera hardware, as well as network interfaces for communication over networks (e.g., 5G, Wi-Fi) to access remote servers or facilitate data sharing, ensuring a unified and responsive user experience across diverse operational contexts.

A telephoto camera, as described herein, may be understood as an optical imaging component integrated into an XR device, configured to capture magnified views of distant objects within the user's environment to enhance detailed observation in XR applications. As shown in FIG. 1, telephoto cameras 106a, 106b may be affixed to the front-facing structure of the XR device 102. Such telephoto cameras may comprise a lens assembly with a long focal length—such as, for example, a fixed or variable telephoto lens (e.g., 50 mm or greater)—designed to narrow the FOV and amplify distant scene elements. The camera includes an image sensor, such as, for example, a charge-coupled device (CCD) or complementary metal-oxide semiconductor (CMOS) sensor, to convert incoming light into digital signals, and may incorporate actuators for precise positional adjustments to facilitate stereoscopic alignment with a paired telephoto camera. In the context of this disclosure, the telephoto camera collaborates with control circuitry (e.g., control circuitry described in FIGS. 20-21) to transmit high-magnification image data to an image processing unit (e.g., any suitable combination of hardware and/or software implemented by the XR device), enabling disparity map generation and parallax correction to help facilitate for binocular zoom functionality. Additionally, the telephoto camera may provide optical zoom mechanisms—such as, for example, liquid lenses or motorized lens elements—controlled by the image processing unit to adjust magnification dynamically, and in some embodiments, it includes stabilization hardware, such as, for example, microelectromechanical systems (MEMS) gimbals, to mitigate motion-induced blur during user head movements, ensuring stable, detailed imagery for applications like digital binoculars or remote collaboration.

A wide-angle camera, as described herein, may be understood as an imaging component embedded within an XR device, engineered to capture a broad FOV of the surrounding environment to provide spatial context in XR experiences. Generally positioned on the outward-facing surface of the XR device, the wide-angle camera comprises a lens assembly with a short focal length—such as, for example, ranging from 10 mm to 35 mm—configured to encompass a wide FOV (e.g., 90 degrees or greater) for comprehensive scene coverage. The camera may be equipped with an image sensor, such as, for example, a CCD or CMOS sensor, to digitize the captured light, and may include fixed or adjustable aperture elements to optimize light intake under varying conditions. Within this disclosure, the wide-angle camera interfaces with control circuitry (e.g., control circuitry described in FIGS. 20-21) to relay broad contextual imagery to the image processing unit, serving as a reference for anchoring telephoto camera inputs during multi-focal exploration and depth alignment tasks. In certain embodiments, the wide-angle camera may incorporate additional features, such as, for example, fisheye lens elements for ultra-wide FOV capture or anti-distortion coatings to minimize edge warping, enhancing the accuracy of spatial awareness in pass-through modes, while supporting seamless transitions with telephoto perspectives for applications like object recognition and/or mixed-reality navigation.

FIG. 2 depicts an illustrative disparity heatmap that integrates both wide-angle and telephoto perspectives, in accordance with some embodiments of this disclosure. In some embodiments, the disparity heatmap 201 may be generated by an image processing unit (e.g., of XR device 102 of FIG. 1) combining a telephoto input 202 with a wide-angle input. In some embodiments, such processing may be performed at least in part at a remote server. In some embodiments, the image processing unit receives input (e.g., one or more captured images) from a telephoto camera and input (e.g., one or more captured images) from a wide-angle camera on the HMD to use as inputs for generating a disparity heatmap 201. Disparity heatmap 201 represents a spatial mapping of disparity values across pixel coordinates of a captured scene, enabling the system to identify and correct parallax mismatches between left and right camera inputs, particularly under telephoto zoom conditions.

In various embodiments, the individual steps to generate the heatmap by one or more components of the computing devices, processes, and systems of FIGS. 1 and 3-21, and may be performed in combination with any of the other processes and aspects described herein.

An image processing unit, as described herein, may be understood as a component within an XR device (and/or implemented at least in part at one or more devices, e.g., a remote server, or other device) configured to process and manage visual data captured by the device's cameras, e.g., comprising a “processing core,” e.g., the central element where computational operations occur, and a “peripheral interface,” e.g., the surrounding elements facilitating data input and output. The processing core may include one or more high-performance processors—such as, for example, a GPU, FPGA, or ASIC—designed to execute real-time image alignment, disparity map generation, and parallax correction for stereoscopic feeds from telephoto and wide-angle cameras. In some embodiments, the processing core further comprises hardware accelerators dedicated to tasks such as, for example, magnification-specific disparity adjustments or predictive alignment computations, enhancing efficiency during dynamic zoom transitions.

The peripheral interface may include camera input ports for receiving synchronized feeds from dual telephoto cameras and a wide-angle camera, memory buffers (e.g., RAM or cache) for storing intermediate frames and disparity data, and communication pathways (e.g., I/O circuitry) to integrate gaze-tracking module outputs and IMU sensor data. In some embodiments, the image processing unit may incorporate control circuitry, such as, for example, microcontrollers or programmable logic devices, to coordinate real-time adjustments-e.g., warping telephoto images based on gaze vectors or stabilizing views using IMU-derived motion data-helping provide consistent depth perception and binocular alignment. In certain embodiments, the image processing unit may extend to cloud connectivity via network interfaces, enabling off-device storage or processing of calibration profiles and historical motion data, complementing onboard capabilities for seamless XR functionality.

In some embodiments, disparity heatmap 201 is structured as a grid of pixel coordinates, each associated with a disparity value and a designated region (e.g., wide-angle or telephoto). For example, pixel coordinates (0,0) to (6,6) may correspond to a portion of the scene captured by the wide-angle camera, with disparity values ranging from 7 to 15, while a portion of the disparity heatmap, e.g., forming a shape of a square in this example, with corners at (1,2), (1,5), (4,2) and (4,5) may reflect a region captured by the telephoto cameras, with disparity values ranging from 7 to 15. In some embodiments, the lighter regions represent distant areas in relation to the user wearing or holding or otherwise proximate to the XR device, while darker regions indicate closer areas in relation to the user wearing or holding or otherwise proximate to the XR device. In some embodiments, the wide-angle section of the heatmap provides a broader contextual view, capturing the overall spatial arrangement of the scene, while the telephoto section overlays finer disparity details within a specific region of interest, offering higher precision for depth calculation.

In some embodiments, the combined disparity map 201 serves as the input for further processing, where the system calculates depth of an object in the environment. The system may calculate depth using the relationship, Z=(f×D₀)/d, where Z is depth, f is the focal length, D₀ is the IPD, and d is the disparity value. By analyzing both wide-angle and telephoto sections of the map, the system identifies misalignments in stereoscopic inputs and applies real-time correction, such as, for example, image transformations or adjustments to the camera zoom levels. The corrections help allow the system to maintain accurate depth perception and binocular alignment.

In some embodiments, to correct for parallax mismatches, the system (e.g., including XR device 102 and/or any other suitable devices, e.g., one or more devices proximate to XR device 102 and/or a remote server(s) in communication with XR device 102 over a communication network) analyzes the combined disparity map to identify systematic offsets or distortions that deviate from expected values. These deviations may be caused by factors such as, for example, user-specific IPD, varying magnification levels between wide-angle and telephoto views, and mechanical tolerances of the camera mounts. The IPD, denoted as D₀, is measured during the initial calibration step and used to define the baseline alignment between the telephoto cameras. The system ensures that objects at the user's focal distance, Zₓ, converge properly in the binocular view, regardless of whether the user is observing through the wide-angle or telephoto perspective. The relationship between disparity, focal length f, and distance Z remains consistent and is recalibrated dynamically for transitions between perspectives.

Using this relationship, the system determines whether to perform adjustments to the camera inputs to maintain alignment. Corrections may be applied through image transformations that involve translation, scaling, or warping of one or both camera inputs. For instance, when switching between wide-angle and telephoto views, horizontal or vertical shifts are introduced to align images based on the calculated disparity values. For magnification adjustments, the zoom factor of each telephoto camera may be fine-tuned to equalize the apparent size of objects in both perspectives, ensuring consistent depth perception across the binocular view.

The system may employ predictive algorithms to anticipate parallax mismatches during user motion or when magnification levels change dynamically. By continuously analyzing incoming data from both wide-angle and telephoto cameras, the system updates the disparity map in real time and applies incremental corrections to prevent, minimize, or reduce disruptions in stereoscopic alignment. The latency of these updates is mitigated using parallel processing architectures within the system, ensuring that adjustments occur without noticeable delay to the user. This may allow the system to maintain stability and visual consistency during dynamic interactions, such as, for example, sudden head movements or rapid zoom transitions.

In some embodiments, prior to generating a heatmap, a calibration and rectification algorithm may be applied to the telephoto input and wide-angle input. For example, the calibration and rectification processes described herein may ensure that the stereoscopic inputs from cameras are accurately aligned, to collect data for disparity analysis and depth computation. In some embodiments, the calibration and rectification algorithms are executed by the image processing unit within the HMD.

In some embodiments, the calibration process begins with determining the intrinsic parameters of each telephoto camera, individually, disposed on the HMD. These intrinsic parameters may include focal lengths (e.g., f_x and f_y along the x- and y-axes), the principal point (e.g., coordinates c_x, c_y representing the optical center), and distortion coefficients (e.g., radial coefficients k_1, k_2, k_3 and tangential coefficients p_1, p_2). Such parameters characterize the internal optical properties of each camera, accounting for lens distortions that affect image formation. To obtain these parameters, the image processing unit may analyze images of a calibration pattern, such as, for example, a chessboard, captured by each camera. For example, a chessboard pattern with known square dimensions (e.g., 25 mm per square) may be positioned at varying distances and orientations within an environment, and multiple images (e.g., 10-20 frames) may be recorded by the cameras. In some embodiments, the image processing unit may apply a calibration algorithm, such as, for example, Zhang's method, to compute the intrinsic parameters by detecting corner points in the chessboard images and solving for the camera's projection model. This step ensures that each camera's image plane accurately represents points in the three-dimensional environment.

Following intrinsic calibration, the system determines the extrinsic parameters defining the relative orientation and position between telephoto cameras. With the intrinsic and extrinsic parameters, the two cameras can be represented by two projection matrices as to how a point in the world can be projected to a point on the image plane, where P1=K1*[I 0], and P2=K2*[R T], where P1 and P2 are the projection matrices for camera 1 and 2, K1 and K2 are the intrinsic matrices for camera 1 and 2, R is a rotation matrix, I is an identity matrix, and T is the translation vector.

The geometry of stereo vision is governed by the epipolar constraint. For corresponding image points x1 in the first image and x2 in the second image, the relation is given by a fundamental matrix F, where (x2)\hat{ }T*F*x1=0. (x2)\hat{ }T means the transpose of x2. This fundamental matrix can be represented by the calibrated intrinsic and extrinsic parameters as: F =K2\hat{ }(−T)*[T]*R*K1\hat{ }(−1). This means for each x1 in camera 1, its corresponding x2 in camera 2 has to lie on a line defined by the epipolar constraint. In order to perform the disparity analysis, rectification techniques may be employed to warp the images so that the epipolar lines become horizontal and aligned between the two images. This rectification process is well known in stereo processing. After rectification, one point on the first image will have its corresponding point on the other image lying on the same row with a displacement, which is the disparity that may be used to estimate the depth. In some embodiments, such techniques, or any other suitable technique, may be used to normalize the telephoto and wide-angle inputs, to facilitate generation of the disparity map.

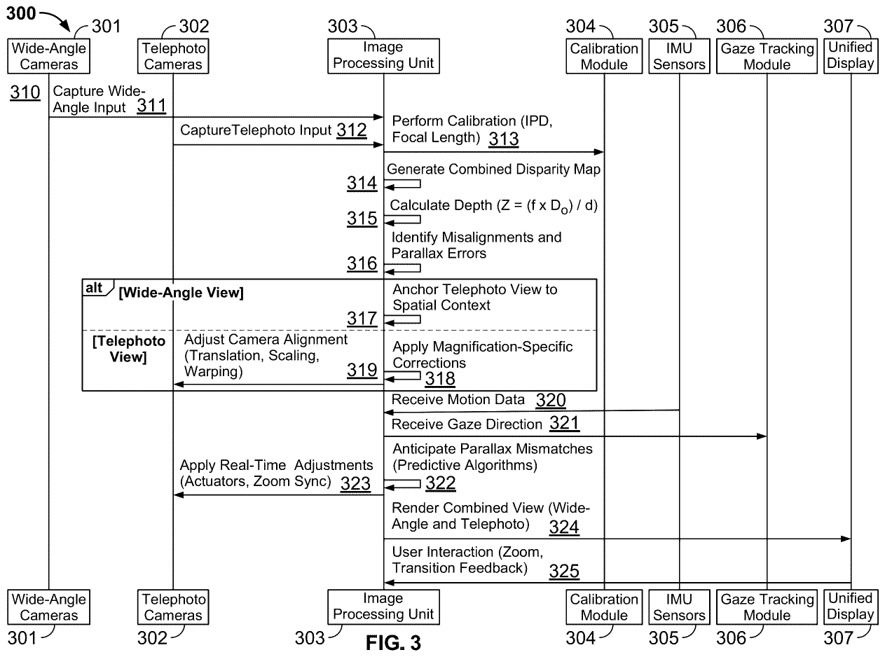

FIG. 3 is a sequence diagram of a process for dynamic parallax correction and binocular zoom alignment of telephoto cameras in an XR HMD, in accordance with some embodiments of this disclosure. As shown in FIG. 3, the system, in some embodiments, comprises a wide-angle camera(s) 301, telephoto camera(s) 302, image processing unit 303, a calibration module 304, IMU sensor 305, gaze-tracking module 306, and a unified display 307. In some embodiments, the systems and process described herein may employ the XR HMD 102 and display 103 illustrated in FIG. 1. Building upon FIGS. 1-2 and 4-21, process 300 may be implemented to dynamically adjust the relative positions and inputs of dual telephoto cameras to address parallax mismatches that are magnified at high zoom levels, ensuring consistent depth perception and binocular alignment in telephoto configurations. The components listed and depicted in FIG. 3 may be similar have the same or similar features as the components described above, and therefore the description of similar features is omitted for brevity. This indicator dynamically adjusts as the user shifts their gaze or zooms in on a region of interest.

In various embodiments, the individual steps of process 300 by one or more components of the computing devices, processes, and systems of FIGS. 1, 2, and 4-21, and may be performed in combination with any of the other processes and aspects described herein. Although the present disclosure may describe certain steps of process 300 (and of other processes described herein) as being implemented by certain components of the computing devices, processes and systems of FIGS. 1, 2, and 4-21, this is for purposes of illustration only. It should be understood that other components of the computing devices, processes, and systems of FIGS. 1, 2, and 4-21 may implement those steps instead.

In some embodiments, the telephoto camera(s) 302 may be a dual telephoto camera (e.g., left telephoto camera and right telephoto camera). In some embodiments, the dual telephoto cameras are each independently mounted and calibrated to provide overlapping field of views.

In some embodiments, the system dynamically adjusts the zoom levels of the dual telephoto cameras based on the user's gaze direction, ensuring that the binocular view centers on the user's focus. This may build on the foundational parallax correction and binocular alignment mechanisms described herein, enabling seamless interaction with the system in real time. In addition to the dual telephoto cameras, the system includes a gaze-tracking module 306, and an image processing unit 303 configured to process gaze data and synchronize zoom adjustments for both cameras. The gaze-tracking module 306, in some embodiments, comprises one or more IR sensors and a processing unit configured to determine the user's point of focus by identifying the gaze vector. In some embodiments, the gaze vector is defined by the direction from the user's eyes to the intended focal point in the scene. The gaze vector may be transmitted to the image processing unit 303, which calculates the required zoom adjustments to center the binocular view on the focus point.

As shown in FIG. 3, XR HMD may comprise, be integrated with, or be in communication with dual telephoto cameras 302 and wide-angle cameras 301. In some embodiments, the XR HMD comprises and employs at least two wide-angle cameras. Dual telephoto cameras 302 may include image sensors such as, for example, CCDs, CMOS, or other optical sensors capable of capturing high-magnification stereoscopic images. These cameras may provide zoom control elements (e.g., optical zoom mechanisms) and alignment actuators (e.g., microelectromechanical systems or MEMS-based position adjusters) to dynamically adjust magnification and orientation. Wide-angle cameras 301 provide a broader FOV for contextual awareness. In some embodiments, the actuators work in conjunction with the image processing algorithms to help ensure that alignment is maintained across a range of operating conditions, particularly during high-magnification use. In some embodiments, the cameras incorporate optical zoom mechanisms that are independently controlled by the image processing unit 303, allowing the system to dynamically adjust magnification while preserving binocular alignment and depth consistency between wide-angle and telephoto views.

The process 300 may begin at 310. At 310, the wide-angle camera(s) 301 captures a wide-angle input (e.g., data from a wide-angle camera detector) and sends the input to an image processing unit 303. Simultaneously and/or sequentially, at 311, a telephoto camera captures telephoto input (e.g., data from a telephoto camera detector) and sends the input to the image processing unit 303. In some embodiments, the image processing unit 303 is configured to receive both inputs. The wide-angle input may be used to maintain spatial consistency and context when transitioning between wide-angle and telephoto inputs.

At 313, image processing unit 303 implements a calibration module 304 to help ensure alignment tailored to user-specific IPD and helps compensate for mechanical tolerances at high zoom levels. In some embodiments, the image processing unit 303 may implement a parallax correction algorithm that operates on inputs from all cameras (e.g., dual telephoto camera(s) 302 and wide-angle camera(s) 301). This algorithm may dynamically analyze stereoscopic inputs from the dual telephoto cameras 302, to adjust disparity identified by the image processing unit 303, amplified by high magnification, while integrating wide-angle camera(s) 301 data to maintain spatial consistency across perspectives. During the calibration process, the system measures the user's IPD. In some embodiments, the calibration process may be run during an initial setup of the XR HMD using reference objects at known distances, helping to ensure that the relationship between disparity, interpupillary distance, and focal distance is accurately mapped for both views. This calibration data is stored in the system's memory. The IPD may be recorded and stored locally on the XR HMD via control circuitry (e.g., control circuitry described in FIGS. 20-21), and may be referenced during real-time operations to compensate for deviations introduced by mechanical tolerances or environmental factors.

At 314, image processing unit 303 generates a disparity map. In some embodiments, the disparity map integrates stereoscopic inputs from the dual telephoto cameras 302 and inputs from wide-angle camera(s) 301, to represent the pixel-by-pixel horizontal or vertical offsets between corresponding points in the left and right images. The image processing unit 303 processes these inputs in real time, producing a combined disparity heatmap, such as, for example, the example provided in the description of FIG. 2.

At 315, at the image processing unit 303, the combined disparity map is used to calculate depth of an object of interest (e.g., object the telephoto camera is focused on). In some embodiments, the depth calculations may be done at the same time as generating the combined disparity map. In some embodiments, steps 314 and 315 may be performed simultaneously, or substantially at the same time, to obtain the disparity and depth data.

At 316, image processing unit 303 identifies misalignments and parallax errors. In some embodiments, the image processing unit 303, upon generating the disparity map, utilizes the disparity map to identify and correct parallax mismatches. For example, upon identifying parallax mismatches (e.g., identifying disparities over an acceptable value) the image processing unit 303 may correct the mismatches by applying image transformations such as, for example, translation or warping to align the telephoto views, ensuring consistent depth perception and binocular alignment at high magnification.

In some embodiments, at 317, the image processing unit 303 may anchor the telephoto view to a spatial context. In some embodiments, at 318, the image processing unit 303 may apply magnification specific correction. At 319, the image processing unit 303 may cause the dual telephoto cameras 302 to adjust alignment (e.g., translation scaling, warping, or any other suitable mechanical adjustment). At 320, the image processing unit 303 receives motion data from an IMU sensor 305.

At 321, the image processing unit 303 receives gaze direction from a gaze-tracking module 306. In some embodiments, the gaze-tracking module 306 uses IR light reflections captured by sensors positioned within the XR HMD. For example, the user's gaze vector is computed based on the position and orientation of the corneal reflections relative to reference points, such as, for example, the centers of the pupils. If the gaze vector is determined to intersect an object at coordinates (X₀, Y₀, Z₀) in the scene, the image processing unit 303 may determine the zoom factor required to magnify this object while maintaining stereoscopic alignment. In some embodiments, the zoom factor Zₓ for each camera is calculated using the relationship: Zₓ=f×(D₀/Dₓ) where f is the focal length, D₀ is the distance to the current focus, and Dₓ is the distance to the new focus based on the gaze vector. The disparity values at the corresponding depth are updated to ensure the binocular view remains consistent after zoom adjustments.

In some embodiments, at 321, the system may use to gaze vector to identify an ROI within a captured scene. In some embodiments, the ROI is dynamically adjusted as the user's gaze shifts. For example, both telephoto cameras 302 may adjust their zoom settings independently to ensure that the object at the user's focal depth is centered and aligned in the binocular view. If the user shifts their gaze to a distant object, the cameras increase their magnification while maintaining alignment, enabling seamless tracking of the object. In some embodiments, the telephoto lenses are fully mechanized.

In some embodiments, the gaze-tracking module 306 or the image processing unit 303 may include a calibration step. For example, the system establishes a baseline for gaze tracking accuracy by mapping known gaze positions to specific objects in the scene. This calibration step ensures that the calculated gaze vectors align precisely with the user's intended focal points. The calibration data is stored in memory and referenced during real-time operations to enhance the accuracy of zoom adjustments and prevent, minimize, or reduce alignment errors.

At 322, the image processing unit 303 may anticipate parallax mismatches with a predictive algorithm(s). For example, to minimize delays, the system may employ predictive algorithms to anticipate gaze shifts and preemptively adjust the zoom levels. Such predictive algorithm(s) may use historical gaze data and motion tracking from IMU sensors 305 to predict the user's next point of focus. By combining predictive modeling with real-time gaze data, the system ensures smooth transitions and prevent, minimize, or reduce lag, enhancing the user's experience.

At 323, the image processing unit 303 causes the real-time adjustments (actuators, Zoom Sync) on the telephoto camera(s). For example, the system may integrate the zoom adjustments with the disparity map. As the zoom levels change, the disparity values are recalculated to maintain accurate depth perception and alignment. In some embodiments, the system may recalibrate to ensure that objects at the focal point remain correctly fused in the binocular view, even at high magnification.

At 324, the image processing unit 303 renders a combined view (e.g., wide-angle and telephoto) and transmits such view to unified display 307. At 325, the image processing unit 303 receives, from the unified display 307, user interactions (e.g., zoom, transition feedback, touch and or gaze direction motions).

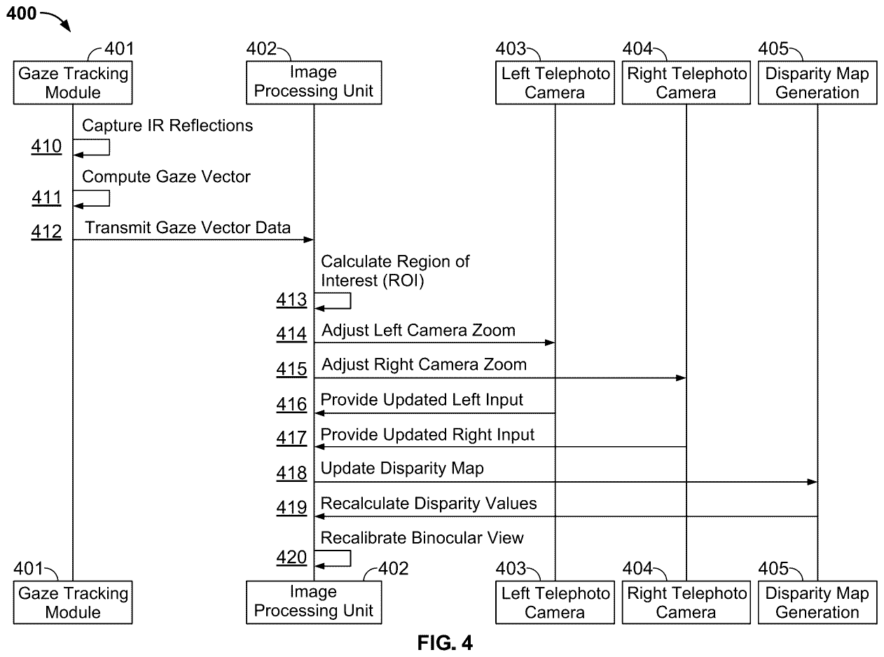

FIG. 4 is a sequence diagram of a process 400 for dynamic parallax correction and binocular zoom alignment of telephoto cameras in an XR HMD, in accordance with some embodiments of this disclosure. Building upon FIGS. 1-3 and 5-21, FIG. 4 provides a detailed visualization of the calibration and rectification s essential for aligning stereoscopic inputs for a left and right telephoto camera within the XR HMD. The components listed and depicted in FIG. 4 may be have the same or similar features as the components described above, and therefore the description of similar features is omitted for brevity. For example, the gaze-tracking module 401, image processing unit 402, telephoto cameras (left 403 and right 404), and disparity map generation 405 of FIG. 4 may be the same as or similar to those described in FIGS. 1-3.

In various embodiments, the individual steps of process 400 may be implemented by one or more components of the computing devices, processes, and systems of FIGS. 1-3 and 5-21 may be performed in combination with any of the other processes and aspects described herein. Although the present disclosure may describe certain steps of process 400 (and of other processes described herein) as being implemented by certain components of the computing devices, processes and systems of FIGS. 1-3 and 5-21, this is for purposes of illustration only. It should be understood that other components of the computing devices, processes, and systems of FIGS. 1-3 and 5-21 may implement those steps instead.

Process 400 may begin at 410. At 410, the gaze-tracking module 401 captures IR reflections. At 411, the gaze-tracking module 401 computes a gaze vector. At 412, the gaze-tracking module 401 transmits gaze vector data to the image processing unit 402. At 413, the image processing unit 402 calculates an ROI. At 414, the image processing unit 402 causes the left telephoto camera 403 to adjust zoom levels. At 415, the image processing unit 402 causes the right telephoto camera 404 to adjust zoom levels. At 416, the image processing unit 402 receives updated left input from the left telephoto camera 403.

At 417, the image processing unit 402 receives updated right input from the right telephoto camera 404. A 418, the image processing unit 402 causes the disparity map generation 405 to update the disparity map. At 419, the image processing unit 402 receives recalculated disparity values from the disparity map generation 405. At 420, the image processing unit 402 recalibrates or re-aims (or updates the aim of) the binocular view.

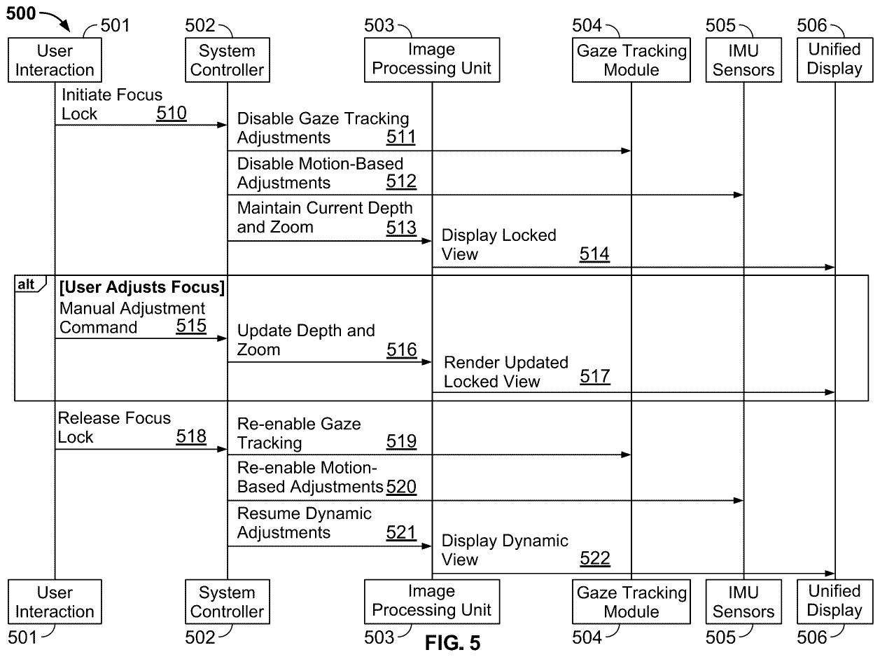

FIG. 5 depicts an illustrative block diagram and process 500 for dynamic parallax correction and binocular zoom alignment of telephoto cameras in an XR HMD, in accordance with some embodiments of this disclosure. Building upon FIGS. 1-4 and 6-21, FIG. 5 provides a detailed visualization of the system allowing a user(s) to manually lock focus on a specific depth or zoom level while temporarily disabling gaze-or motion-based adjustments. The components listed and depicted in FIG. 5 may have the same or similar features as the components described above, and therefore the description of similar features is omitted for brevity.

In various embodiments, the individual steps of process 500 may be implemented by one or more components of the computing devices, processes, and systems of FIGS. 1-3 and 6-21 may be performed in combination with any of the other processes and aspects described herein. Although the present disclosure may describe certain steps of process 500 (and of other processes described herein) as being implemented by certain components of the computing devices, processes and systems of FIGS. 1-3 and 6-21, this is for purposes of illustration only. It should be understood that other components of the computing devices, processes, and systems of FIGS. 1-4 and 6-21 may implement those steps instead.

Process 500 may begin at 510. At 510, a user interaction 501 is received by the XR HMD that initiates focus lock. At 511, the system controller 502 causes the gaze-tracking module 504 to disable gaze tracking adjustments. At 512, the system controller 502 causes the IMU sensor 505 to disable motion-based adjustments. At 513, the system controller 502 maintains current depth and zoom. At 514, the image processing unit 503 causes the unified display 506 to display a locked view (e.g., image). At 515, the user interaction 501 may be received by the system controller 502 (e.g., manual adjustment command) to manually adjust focus.

At 516, the system controller 502 causes the image processing unit 503 to update depth and zoom. At 517, the image processing unit 503 causes the unified display 506 to render an updated locked view. At 518, the user interaction 501 may be received by the XR HMD and system controller 502 to release the focus lock. At 519, the system controller 502 causes the gaze-tracking module 504 to re-enable gaze tracking. At 520, the system controller 502 causes the IMU sensor 505 to re-enable motion-based adjustments. At 521, the system controller 502 causes the image processing unit 503 to resume dynamic adjustments. At 522, the image processing unit 503 causes the unified display 506 to display dynamic view.

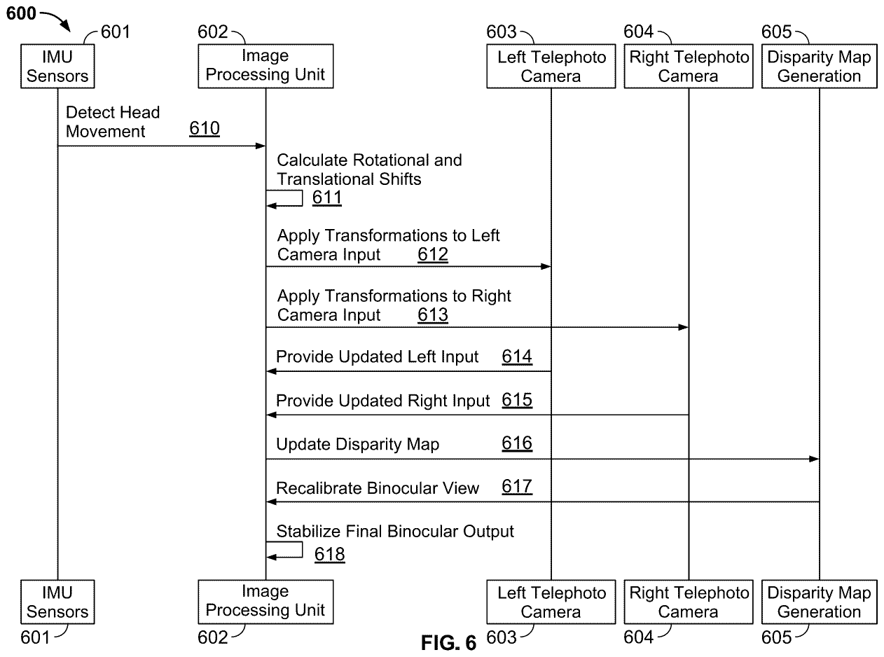

FIG. 6 is a sequence diagram of a process 600 for dynamic parallax correction and binocular zoom alignment of telephoto cameras in an XR HMD, in accordance with some embodiments of this disclosure. Building upon FIGS. 1-5 and 6-21, FIG. 5 provides a detailed visualization of the system to dynamically stabilizes the binocular view of the dual telephoto cameras in response to user head movements and environmental changes. The components listed and depicted in FIG. 6 may have the same or similar features as the components described above, and therefore the description of similar features is omitted for brevity.

In various embodiments, the individual steps of process 600 may be implemented by one or more components of the computing devices, processes, and systems of FIGS. 1-5 and 7-21 may be performed in combination with any of the other processes and aspects described herein. Although the present disclosure may describe certain steps of process 600 (and of other processes described herein) as being implemented by certain components of the computing devices, processes and systems of FIGS. 1-5 and 7-21, this is for purposes of illustration only. It should be understood that other components of the computing devices, processes, and systems of FIGS. 1-5 and 7-21 may implement those steps instead.

In some embodiments, the system ensures that stereoscopic alignment and depth perception remain consistent, even during dynamic interactions (e.g., rapid head motions or shifts in the field of view). This may build on the parallax correction and gaze-driven zoom synchronization mechanisms described herein by introducing motion stabilization to maintain a steady and accurate binocular output.

In some embodiments, the XR HMD includes dual telephoto cameras (e.g., left telephoto camera 603 and right telephoto camera 604), IMU sensors 601 integrated into the XR headset, and an image processing unit 602 configured to process motion data and apply real-time adjustments to the camera inputs. In some embodiments, the IMU sensor(s) 601 continuously measure linear acceleration and angular velocity across three axes (e.g., x-axis, y-axis, z-axis), providing detailed motion data (e.g., motion data corresponding to a user's head movements). In some embodiments, the data is transmitted to the image processing unit 602, which calculates the corresponding adjustments for preserving binocular alignment and depth perception.

Process 600 may begin at 610. At 610, the IMU sensor 601 causes the image processing unit 602 to detect movement of the XR HMD (e.g., user head movements). When head movement is detected, the processing unit uses the IMU data to determine the rotational and translational shifts of the XR headset relative to the initial calibrated position.

At 611, the image processing unit 602 calculates rotational and translational shifts. For example, the adjustments are calculated using transformation matrices that map the detected motion to corresponding shifts in the camera inputs. For rotational movements, the system applies corrections using a rotation matrix R, defined as: R=Rₓ(θₓ)×R_{γ}(θ_{γ})×R_z(θ_z) where θ_{γ}, θ_{γ}, and θ_z are the angular displacements around the X, Y, and Z axes, respectively. For translational shifts, the displacement vector T is applied to adjust the camera inputs: T=[Δx, Δy, Δz]. The system combines these transformations to align the binocular view dynamically, ensuring that objects remain properly positioned and fused in the stereoscopic output.

In some embodiments, in high-magnification scenarios, small user movements can significantly amplify alignment errors, leading to visual discomfort or loss of depth perception. To address this, the system employs predictive motion algorithms that anticipate user movements based on historical IMU data. These algorithms, implemented using Kalman filters, estimate the next probable position of the headset and preemptively adjust the camera inputs to stabilize the binocular view. This predictive technique may help minimize latency and ensures smooth transitions, even during rapid or erratic head motions.

At 612, the image processing unit 602 applies the transformation to the left telephoto camera 603. At 613, the image processing unit 602 applies the transformations to the right telephoto camera 604. At 614, the left telephoto camera 603 provides updated left telephoto input to the image processing unit 602. At 615, the right telephoto camera 604 provides updated right telephoto input to the image processing unit 602.

At 616, the image processing unit 602 updates the disparity map on the disparity map generation 605. At 617, the disparity map generation 605 causes the image processing unit 602 to recalibrate binocular view.

At 618, the image processing unit 602 stabilizes final binocular output. In some embodiments, the XR HMD integrates the motion stabilization process with the gaze-driven zoom synchronization and disparity correction mechanisms described herein. As the user's motion shifts the field of view, the system recalibrates the disparity map and updates the zoom levels to maintain alignment and focus on the user's intended object of interest. These recalibrations ensure that the binocular view remains centered and consistent, regardless of user movements. During the initialization phase, the system performs a motion calibration step to establish a baseline for IMU accuracy. This calibration involves mapping specific head positions to corresponding camera alignments, ensuring that the motion data aligns precisely with the system's internal coordinate framework. The calibration data is stored in memory and referenced during real-time operations to enhance the accuracy of motion stabilization.

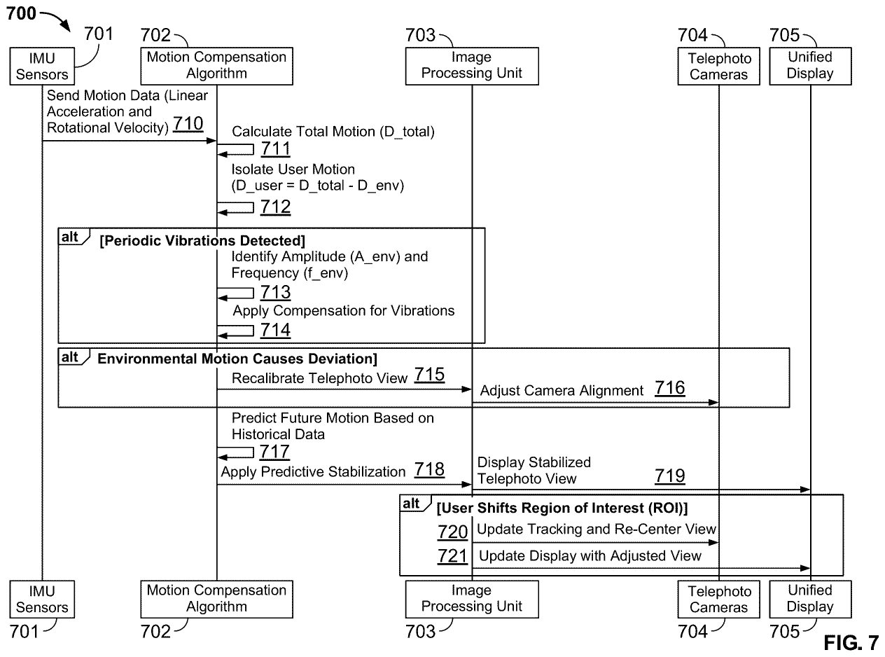

FIG. 7 is a sequence diagram of a process 700 for dynamic parallax correction and binocular zoom alignment of telephoto cameras in an XR HMD, in accordance with some embodiments of this disclosure. Building upon FIGS. 1-6 and 8-21, FIG. 7 provides a detailed visualization of the system to dynamically stabilize the binocular view of the dual telephoto cameras in response to dynamic environmental changes. The components listed and depicted in FIG. 7 may have the same or similar features as the components described above, and therefore the description of similar features is omitted for brevity.

In various embodiments, the individual steps of process 700 may be implemented by one or more components of the computing devices, processes, and systems of FIGS. 1-6 and 8-21 may be performed in combination with any of the other processes and aspects described herein. Although the present disclosure may describe certain steps of process 700 (and of other processes described herein) as being implemented by certain components of the computing devices, processes and systems of FIGS. 1-6 and 8-21, this is for purposes of illustration only. It should be understood that other components of the computing devices, processes, and systems of FIGS. 1-6 and 8-21 may implement those steps instead.

In some embodiments, the XR HMD is configured to adapt to dynamic environments, such as, for example, when a user operates the device within a moving vehicle (e.g., train, car, bike, etc.) to ensure image stability tracking and usability. A motion compensation algorithm 702 may be implemented by the XR device and/or the image processing unit 703.

Process 700 may begin at 710. At 710, the IMU sensor 701 collects and sends motion data (e.g., linear acceleration, and rotational velocity) of the XR HMD to a motion compensation algorithm 702. The IMU may comprise components to differentiate between user-induced movements, such as, for example, head rotations, and environmental perturbations, including vibrations, accelerations, or jolts imparted by the vehicle. The IMU sensors may continuously monitor linear acceleration and rotational velocity across multiple axes, capturing the combined effects of user and environmental motion.

In some embodiments, a total displacement vector, encompassing contributions from both user and environmental motion, is computed by the image processing unit. In some embodiments, the image processing unit isolates the user-specific motion component by subtracting the environmental motion contribution, yielding a refined displacement vector that reflects only deliberate user movements. This separation ensures that adjustments to the telephoto cameras' view are driven solely by the user's intentional actions, maintaining focus on the desired object of interest. If the train induces vibrations characterized by a specific amplitude and frequency, the image processing unit calculates the resulting displacement and applies an inverse transformation to counteract it, stabilizing the viewport and preserving alignment with the targeted object.

At 711, the motion compensation algorithm 702 calculates total motion (e.g., D_total). The total displacement vector, which includes contributions from both user and environmental motion, is represented as D_total. At 712, the motion compensation algorithm 702 isolates user motion by subtracting the environmental motion component, yielding D_user=D_total−D_env.

At 713, the motion compensation algorithm 702 detects periodic vibrations by first identifying amplitude and frequency. For example, if the IMU sensors detect consistent vibrations along a particular axis (common in a moving train) the system identifies this as periodic noise and subtracts its effect from the total motion data. If the train generates vibrations of amplitude A_env at a frequency f_env, the system calculates and compensates for the displacement caused by these oscillations, effectively stabilizing the viewport.

At 714, the motion compensation algorithm 702 applies the compensation for vibrations. At 715, the motion compensation algorithm 702 sends a signal to the image processing unit 703 to recalibrate the telephoto view. Upon receiving the signal, the image processing unit 703, at 716, causes the telephoto camera 704 to adjust camera alignment.

At 717, the motion compensation algorithm 702 incorporates predictive stabilization mechanisms to anticipate future environmental disruptions. The motion compensation algorithm 702 may collect and analyze historical motion data collected from the IMU, recurring patterns—such as, for example, periodic accelerations or abrupt jolts—are identified. For example, if the train's motion exhibits regular acceleration cycles, the system employs predictive modeling to preemptively adjust the telephoto view, applying corrections before the disturbances fully manifest. This forward-looking approach may help minimize the user's perception of instability, delivering a smoother and more comfortable viewing experience during prolonged interactions within such dynamic settings. At 718, the motion compensation algorithm 702 may send signals to the image processing unit 703 to apply predictive stabilization.

At 719, the image processing unit 703 sends signals to the unified display 702 applying the calculate predictive stabilization at the user's-end. At 720, the image processing unit 703 may shift the ROI by causing the telephoto camera to update tracking and recenter view. At 721, the image processing unit 703 may send signals to the unified display to update the display with the adjusted view.

In some embodiments, real-time object tracking is integrated to maintain the telephoto view's focus on the user's ROI despite environmental motion. Should the viewport deviate from the intended object due to external forces, the system recalibrates the telephoto cameras' alignment using positional and depth data derived from a disparity map, as established in earlier embodiments. For instance, if a lateral jerk from the train shifts the object's position within the viewport, the image processing unit computes the object's new coordinates and adjusts the cameras to seamlessly re-center it, ensuring uninterrupted tracking.

To illustrate this example, consider a scenario where a user, aboard a moving train, manually requests that the XR HMD zoom in on a distant building or a passing vehicle. The train's vibrations may induce small, repetitive displacements along the vertical axis, while sudden lateral shifts occur during turns or stops. The image processing unit may compensate for these disturbances in real time, stabilizing the telephoto view to keep the building or vehicle consistently aligned and in focus. By anticipating the train's periodic motion through predictive stabilization, the frequency of performing recalibrations may be reduced, enhancing stability and user comfort. By predicting the periodic motion of the train, the system further reduces the frequency of performing recalibrations, creating a more stable and comfortable user experience.

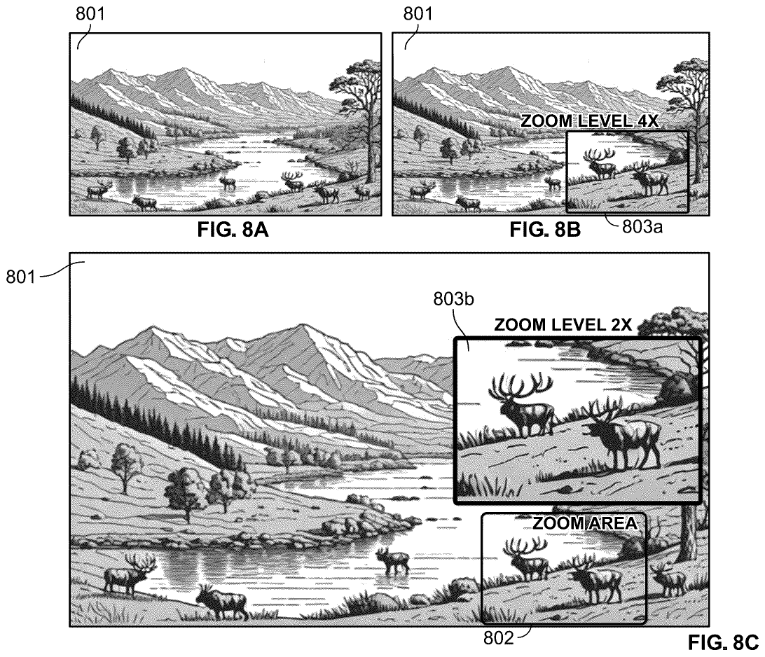

FIGS. 8A-8C show illustrative examples of a scene generated on a unified display with a wide-angle input overlayed with a telephoto input, in accordance with embodiments of this disclosure. As shown in FIG. 8A, the unified display may show a captured scene from a wide-angle camera of the environment surrounding the HMD. For example, the wide-angle input 801 may be first captured and generated for display on the unified display of the HMD, and the scene may be sent as video on the unified display.

As shown in FIG. 8B, a telephoto input 803a, along with a virtual sign indicating zoom level (e.g., “ZOOM LEVEL 4×”) may overlap the wide-angle input 801. In some embodiments the zoomed in overlay (e.g., telephoto input 803a) is directionally aimed in parallel with the gaze vector (e.g., eye gaze). In some embodiments, the telephoto input 803a is overlapped to the ROI identified on the wide-angle input 801.

In some embodiments, as shown in FIG. 8C, the telephoto input 803b may be placed anywhere on the display, overlapping the wide-angle input 801. In some embodiments, the ROI (e.g., zoom area) 802 may be displayed and outlined on the wide-angle input and alongside the telephoto input 803b.

In some embodiments, the display system adapts to user preferences (e.g., in the user profile on the XR HMD) and interaction modes. For instance, when the user's gaze focuses on a distant object, the telephoto view may dynamically expand to occupy a larger portion of the display, emphasizing detail. Conversely, when the user looks back at the broader scene, the system rebalances the perspectives, prioritizing the wide-angle view while maintaining the telephoto focus.

In some embodiments, to minimize visual distractions, the system (e.g., image processing unit) may employ transition-smoothing algorithms (e.g., SLERP, Spherical Linear Interpolation or a suitable modification thereof) that interpolate between changes in perspective. These algorithms ensure that shifts between wide-angle and telephoto views occur seamlessly, avoiding, minimizing, or reducing abrupt changes that may disrupt the user experience.

In some embodiments, the XR HMD performs an initial calibration step to align the wide-angle and telephoto cameras. During this phase, reference objects at known distances are used to map the spatial relationship between the perspectives. This calibration data helps properly align both views in real-time operations, mitigating inconsistencies or depth distortions.

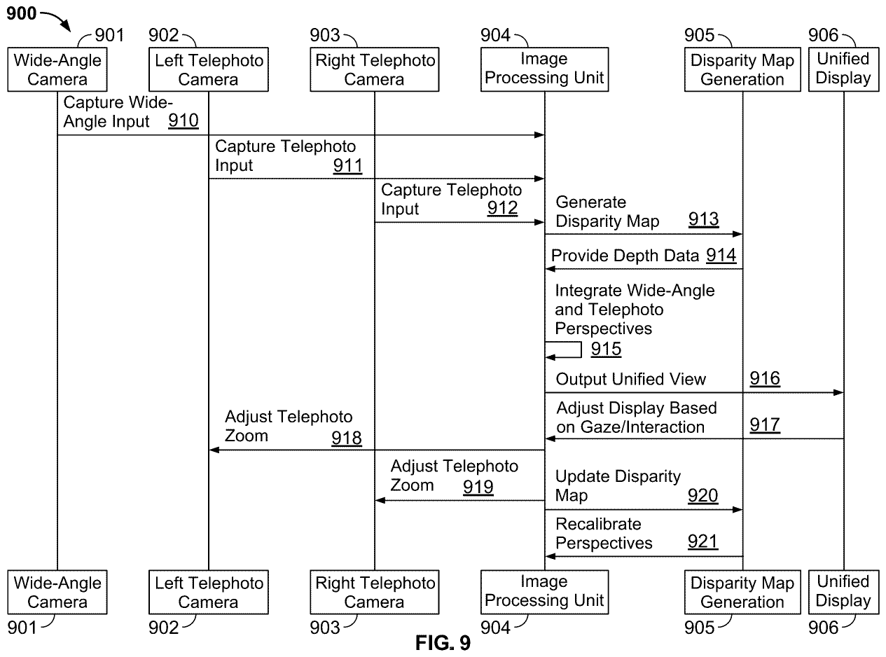

FIG. 9 depicts an illustrative block diagram and process for dynamic parallax correction and binocular zoom alignment of telephoto cameras in an XR HMD, in accordance with some embodiments of this disclosure. Building upon FIGS. 1-8 and 10-21, FIG. 9 provides a detailed visualization of the system that implements adaptive depth transitions to ensure smooth and visually comfortable adjustments between varying focal depths and magnification levels. The components listed and depicted in FIG. 9 may have the same or similar features to the components described above, and therefore the description of similar features is omitted for brevity.

In various embodiments, the individual steps of process 900 may be implemented by one or more components of the computing devices, processes, and systems of FIGS. 1-8 and 10-21 may be performed in combination with any of the other processes and aspects described herein. Although the present disclosure may describe certain steps of process 900 (and of other processes described herein) as being implemented by certain components of the computing devices, processes and systems of FIGS. 1-8 and 10-21, this is for purposes of illustration only. It should be understood that other components of the computing devices, processes, and systems of FIGS. 1-8 and 10-21 may implement those steps instead.

Process 900 may begin at 910. At 910, the wide-angle camera 901 captures wide-angle input and transmits the input to the image processing unit 904. At 911, the left telephoto camera 902 captures telephoto input and transmits the input to the image processing unit 904.

At 912, the right telephoto camera 903 captures telephoto input and transmits the input to the image processing unit 904. At 913, the image processing unit 904 implements disparity map generation 905 to generate a disparity map.

At 914, the disparity map generation 905 provides depth data 914 to the image processing unit 904. At 915, the image processing unit 904 integrates wide-angle and telephoto perspectives, based at least in part on the disparity map. At 916, the image processing unit 904 causes the unified display 906 to output the unified/integrated view. At 917, the image processing unit 904 causes the unified display 906 to adjust the display based on gaze interaction.

At 918, the image processing unit 904 causes the left telephoto camera 902 to adjust zoom levels. At 919, the image processing unit 904 causes the right telephoto camera 903 to adjust zoom levels. At 920, the image processing unit 904 sends signals to the disparity map generation 905 to update the disparity map. For example, the recalibration process may help enforce perspective alignment when depth information changes, e.g., based on step 920 using new depth data to update disparity map and maintain accurate depth perception. At 921, the disparity map generation 905 causes the image processing unit 904 to recalibrate perspectives (e.g., using new depth data to update the disparity map and help maintain accurate depth perception).

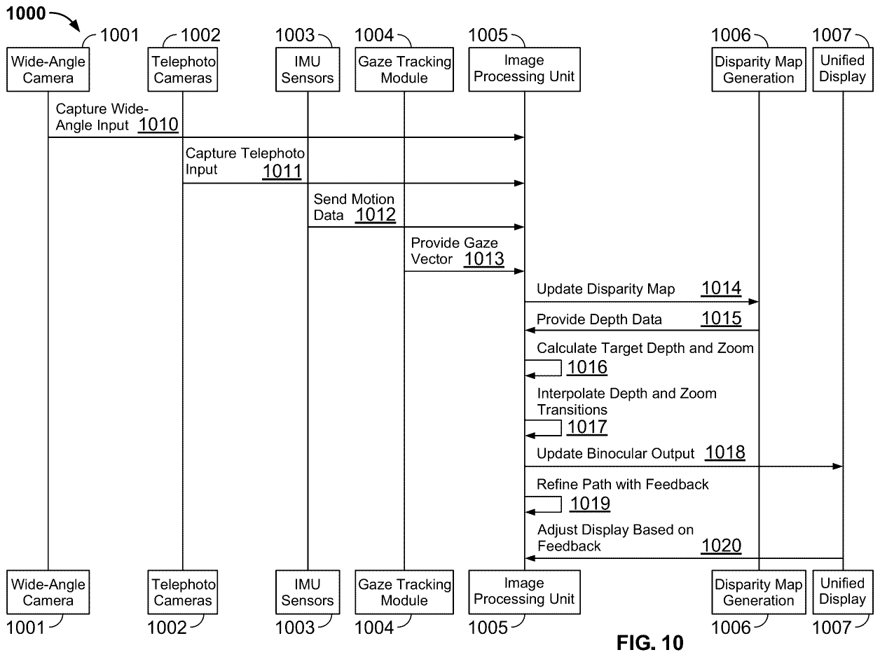

FIG. 10 depicts an illustrative block diagram and process 1000 for dynamic parallax correction and binocular zoom alignment of telephoto cameras in an XR HMD, in accordance with some embodiments of this disclosure. Building upon FIGS. 1-9 and 11-21, FIG. 10 provides a detailed visualization of the system that implements adaptive depth transitions to ensure smooth and visually comfortable adjustments between varying focal depths and magnification levels. The components listed and depicted in FIG. 10 may have the same or similar features to the components described above, and therefore the description of similar features is omitted for brevity. This may help build upon parallax correction, gaze-driven zoom synchronization, motion stabilization, and multi-focal exploration mechanisms, and/or any other suitable aspects described herein, to help minimize, reduce, or avoid abrupt changes in depth perception and binocular alignment.

In various embodiments, the individual steps of process 1000 may be implemented by one or more components of the computing devices, processes, and systems of FIGS. 1-9 and 11-21 may be performed in combination with any of the other processes and aspects described herein. Although the present disclosure may describe certain steps of process 1000 (and of other processes described herein) as being implemented by certain components of the computing devices, processes and systems of FIGS. 1-9 and 11-21, this is for purposes of illustration only. It should be understood that other components of the computing devices, processes, and systems of FIGS. 1-9 and 11-21 may implement those steps instead.

At 1010, the wide-angle camera 1001 (e.g., camera 108 of FIG. 1) captures a wide-angle input and transmits the input to the image processing unit 1005. At 1011, the telephoto camera(s) 1002 (e.g., cameras 106a and/or 106b of FIG. 1) captures telephoto input and transmits the input to the image processing unit 1005. In some embodiments, both wide-angle and telephoto input may be sent simultaneously or at different time intervals. At 1012, the IMU sensor(s) 1003 sends motion data to the image processing unit. At 1013, the gaze-tracking module 1004 provides a gaze vector to the image processing unit 1005.

In some embodiments, process 1000 dynamically interpolates depth and zoom adjustments, ensuring that transitions between wide-angle and telephoto views, or between different ROIs, occur as seamless as possible. The interpolation is controlled by the image processing unit 1005, which processes input from the wide-angle 1001 and telephoto 1002 cameras, gaze-tracking module 1004, and IMU sensors 1003. These components provide real-time data on user motion, gaze direction, and scene geometry of the surrounding environment.

At 1014, the image processing unit 1005 causes the disparity map generation 1006 by updating the disparity map. At 1015, the disparity map generation 1006 provides depth data to the image processing unit 1005. At 1016, the image processing unit 1005 calculates target depth and zoom. For example, based on the depth map and other settings, the system can calculate the depth of the target, and determine what the zoom level is at the target region, and interpolate the zoom level to the neighboring area, based on the depth map of the scene. At 1017, the image processing unit 1005 interpolates depth and zoom transitions. At 1018, the image processing unit 1005 causes the unified display 1007 to update binocular output. At 1019, the image processing unit 1005 refines the path with feedback. At 1020, the unified display 1007 causes the image processing unit 1005 to adjust display based on feedback.

In some embodiments, when a depth transition is triggered—such as, for example, by a gaze shift to a different focal point or a zoom adjustment—the system calculates the required adjustments to disparity, depth, and magnification. The disparity map generated (e.g., the disparity map of FIG. 2), in some embodiments, serves as the foundation for recalculating depth values during the transition. Using the relationship Z=(f×D₀)/d, where Z is the depth, f is the focal length, D₀ is the interpupillary distance, and d is the disparity value, the system determines the depth values at both the starting and target focal points.

In some embodiments, the transition between these depths is interpolated over a defined time interval to avoid, minimize, or reduce abrupt shifts. For depth interpolation (e.g., 1017), the process may use a cubic or linear interpolation algorithm, ensuring that the depth changes occur gradually. The interpolated depth at time t is calculated as: Z(t)=Zₛ+(Zₜ−Zₛ)×(t/T) where Zₛ is the starting depth, Zₜ is the target depth, t is the current time step, and T is the total duration of the transition. Similar interpolation is applied to the zoom levels of the telephoto cameras, ensuring that the magnification adjusts as smoothly as possible during the transition.

In some embodiments, process 1000 employs motion stabilization, to maintain alignment and stability during the depth transition. Predictive algorithms analyze IMU data to anticipate user movements and adjust the transition path accordingly. For example, if the user moves their head while a depth transition is in progress, the system dynamically recalibrates the transition to ensure that the binocular view remains consistent.

The following is an example algorithm for predicting future user focus and motion states by integrating gaze trajectory, head movement patterns, and scene context, allowing depth and zoom transitions. Process 1000 collects data, capturing gaze vector information such as, for example, position and angular velocity, head motion data including linear acceleration and angular velocity from IMU sensors, and scene context from the disparity map and depth data. These inputs provide information about the user's current focus, motion dynamics, and ROIs in the scene. Gaze velocity is calculated as ωg=Δθg/Δt, where Δθg represents the angular displacement of the gaze vector over time Δt. Motion dynamics are analyzed by computing head acceleration and angular velocity, enabling an understanding of the movement of the user trajectory. Scene context is evaluated to identify ROIs based on attributes such as, for example, proximity, size, and visual prominence. Each ROI is assigned a prominence score Si, which is weighted by its relevance to the user's focus.

In some embodiments, to predict user interactions, the system may use a Kalman filter to estimate the next gaze position Pg+1 as: Pg+1=Pg+Vg×Δt+0.5ΔagΔΔt², where ag is the estimated gaze acceleration. Similarly, the next head position Mh+1 is predicted using angular velocity and linear acceleration data, calculated as: Mh+1=Mh+h×Δt+0.5Δah×Δt².

In some embodiments, the predicted gaze and motion trajectories are combined with scene data to determine the most likely ROI. The algorithm prioritizes the ROI with the highest weighted prominence score: ROIp=argmax(Si×Wi), where Si is the prominence score of ROI i, and Wi is its weight based on proximity and focus likelihood.

In some embodiments, once the ROI is identified, the system computes the target depth Zt and zoom factor Zx required to center the binocular view on the ROI. The depth Zt is calculated as: Zt=(f×Do)/d, where f is the focal length, Do is the interpupillary distance, and d is the predicted disparity at the ROI. The transition between the current depth Zc and the target depth Zt is interpolated using: Zinterp(t)=Zc+(Zt×Zc)×(t/T), where T is the total transition duration. Similarly, zoom transitions are interpolated to ensure smooth adjustments.

In some embodiments, operating as a real-time feedback loop, the system may continuously refine predictions by comparing actual user inputs against the predicted trajectories. If deviations occur, the algorithm can dynamically adjust the interpolation paths to maintain alignment and consistency. For example, if a user unexpectedly moves their head during a depth transition, the algorithm recalculates the trajectory and adapts the transition to match the new movement pattern.

In some embodiments, by integrating gaze tracking, motion dynamics, and scene context, the system aims to ensure visually comfortable transitions. For example, when a user alternates focus between a distant marker and a nearby object, the algorithm anticipates the shift, preemptively adjusts zoom and depth, and provides a smooth transition by dynamically recalibrating the binocular view and interpolating depth changes. This capability is useful during multi-focal exploration, where the user may frequently shift focus between wide-angle and telephoto views. By creating transitions, the system attempts to prevent, minimize, or reduce abrupt changes that may disrupt depth perception or cause discomfort. Additionally, the smoothing mechanisms extend to interactions involving gaze-driven zoom adjustments, ensuring that the ROI remains visually stable and properly aligned as the zoom level dynamically changes in response to user interactions.

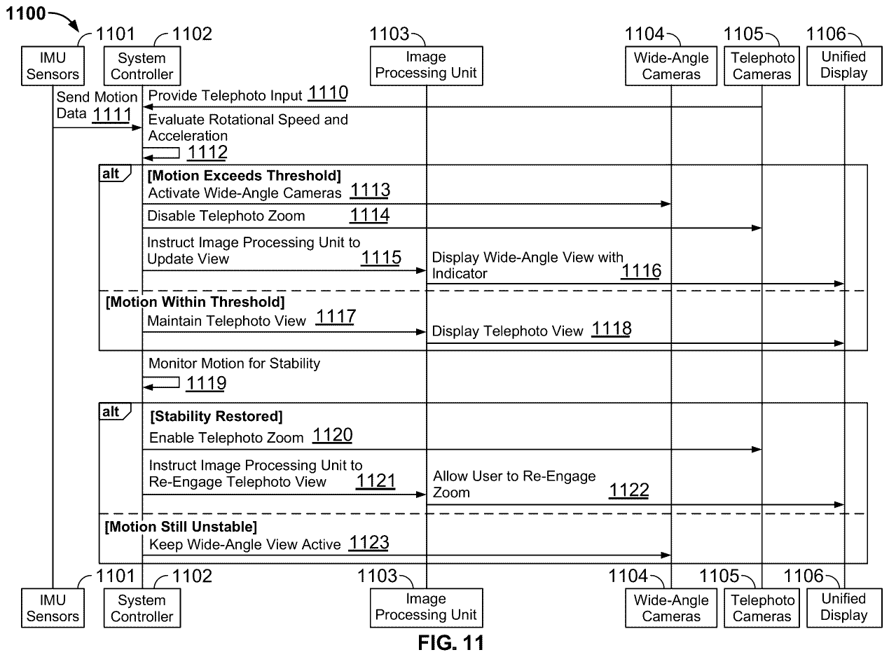

FIG. 11 depicts an illustrative block diagram and process 1100 for dynamic parallax correction and binocular zoom alignment of telephoto cameras in an XR HMD, in accordance with some embodiments of this disclosure. Building upon FIGS. 1-10 and 12-21, FIG. 11 provides a motion-based fallback mechanism designed to prevent, minimize, or reduce user discomfort during rapid head movements while using zoomed telephoto views. The components listed and depicted in FIG. 11 may have the same or similar features to the components described above, and therefore the description of similar features is omitted for brevity. This mechanism dynamically transitions the view to the normal passthrough (wide-angle) cameras when it detects abrupt motion that exceeds predefined thresholds for head movement.

In various embodiments, the individual steps of process 1100 may be implemented by one or more components of the computing devices, processes, and systems of FIGS. 1-10 and 12-21 may be performed in combination with any of the other processes and aspects described herein. Although the present disclosure may describe certain steps of process 1100 (and of other processes described herein) as being implemented by certain components of the computing devices, processes and systems of FIGS. 1-10 and 12-21, this is for purposes of illustration only. It should be understood that other components of the computing devices, processes, and systems of FIGS. 1-10 and 12-21 may implement those steps instead.

At 1110, the telephoto cameras 1105 provide telephoto input to the system controller 1102. At 1111, the IMU sensors 1101 sends motion data to the system controller 1102. At 1112, the system controller 1102 evaluates rotation speed and acceleration. In some embodiments, the process 1100 uses the XR HMD's IMU sensors 1101 to monitor head motion, and an image processing unit 1103 that evaluates motion data and controls transitions. In some embodiments, the IMU sensors 1101 continuously measure motion dynamics, including rotational speed and acceleration, across three axes. Process 1100 analyzes this data in real time to determine whether the user's head movement is within a comfortable range or has exceeded the thresholds set to trigger a fallback.

In some embodiments, the XR HMD may exceed a motion threshold. At 1113, the system controller 1102 causes the wide-angle camera(s) 1104 to activate. At 1114, the system controller 1102 may cause the telephoto camera 1105 zoom to disable. At 1115, the system controller 1102 may cause the image processing unit 1103 to update view. At 1116, the image processing unit 1103 causes the unified display 1106 to display the wide-angle view with an indicator.

In some embodiments, when the user engages the telephoto zoom, the IMU sensors monitor the movement of the XR headset. If the system detects that rotational speed or acceleration exceeds predefined thresholds—indicating a rapid or abrupt head movement—it initiates the fallback mechanism. This triggers an immediate transition to the normal passthrough view, utilizing the wide-angle cameras to provide a stable and contextually complete visual experience. The telephoto zoom is temporarily disabled, and its state is reset to ensure that, when reactivated, it provides a default and properly aligned view.

For example, when the user engages the telephoto zoom as described in above embodiments, the IMU sensors monitor the movement of the XR headset. If the system detects that rotational speed or acceleration exceeds predefined thresholds—indicating a rapid or abrupt head movement—it initiates the fallback mechanism. This triggers an immediate transition to the normal passthrough view, utilizing the wide-angle cameras to provide a stable and contextually complete visual experience. The telephoto zoom is temporarily disabled, and its state is reset to ensure that, when reactivated, it provides a default and properly aligned view.

In some embodiments, motion may be determined to be within the threshold. At 1117, the system controller 1102 causes the image processing unit 1103 to maintain telephoto views. At 1118, the image processing unit 1103 sends signals to the unified display 1106 to display the telephoto views.

At 1119, the system controller 1102 monitors motion for stability. In some embodiments, once stability is restored (e.g., at 1120) the system controller 1102 enables telephoto zoom on the telephoto cameras 1105. At 1121, the system controller 1102 instructs the image processing unit 1103 to reengage telephoto zoom. At 1122, the image processing unit 1103 allows the user to re-engage zoom on the unified display 1106. In some embodiments, the motion is detected to be continuously unstable (e.g., determined to be unstable along a time interval), and, at 1123, the system controller 1102 causes the wide-angle camera(s) 1104 to keep the wide-angle views active.

In some embodiments, during the fallback, the system may display a subtle indicator, such as, for example, a message or border overlay, to inform the user of the transition. The fallback may remain active until the IMU sensors detect that head motion has stabilized. Stabilization is defined by motion dynamics returning to a comfortable range below the thresholds for rotational speed and acceleration. Once the movement stabilizes, the system may automatically re-enables the telephoto zoom functionality if the user returns to looking at the ROI, allowing the user to re-engage it either manually through interaction or automatically if the system detects a sustained focus.

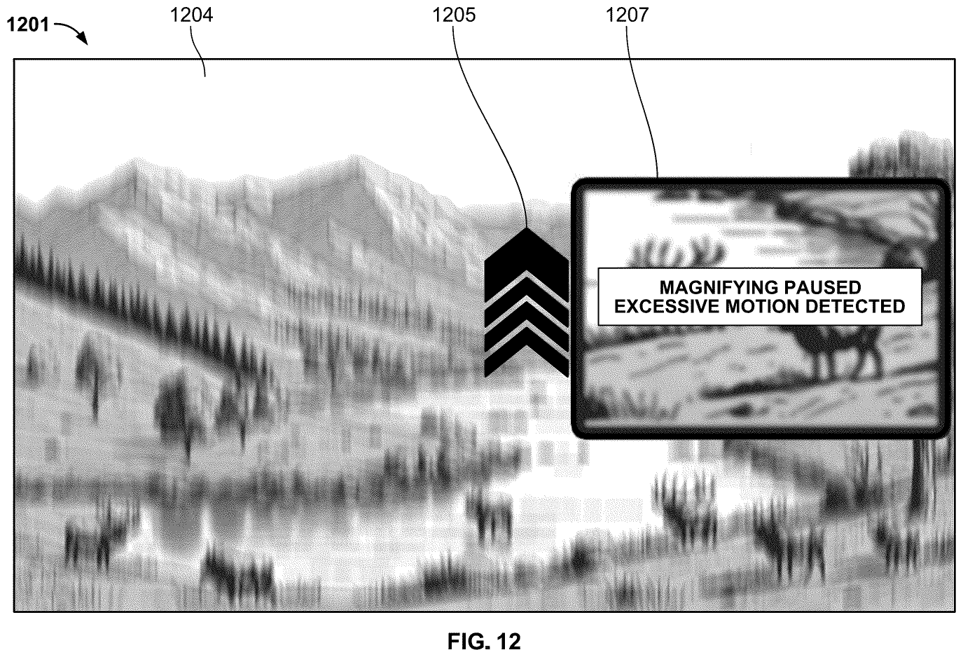

FIG. 12 depicts a rendering of a unified display 1201 on an XR HMD, in accordance with some embodiments of this disclosure. Building upon FIGS. 1-11 and 12-21, FIG. 12 provides an illustrative example of process 1200, pausing, at least a portion of the display (e.g., a telephoto zoomed portion of the display or magnified view) in response to the system on the XR HMD detecting high levels of motion. The components listed and depicted in FIG. 12 may have the same or similar features to the components described above, and therefore the description of similar features is omitted for brevity.

In various embodiments, the unified display 1201 (e.g., employed in process 1200 and also described in relation to FIG. 1) may be implemented by one or more components of the computing devices, processes, and systems of FIGS. 1-11 and 13-21 may be performed in combination with any of the other processes and aspects described herein. Although the present disclosure may describe certain steps of process 1100 (and of other processes described herein) as being implemented by certain components of the computing devices, processes and systems of FIGS. 1-11 and 13-21, this is for purposes of illustration only. It should be understood that other components of the computing devices, processes, and systems of FIGS. 1-11 and 13-21 may implement those steps instead.

FIG. 12 depicts the unified display on the XR HMD. The system utilized by the XR HMD may cause the display to pause telephoto input 1207 when detecting high rate of motion. High rate of motion may be tolerable in the wide-angle view 1204 but may cause discomfort in the telephoto view 1207.

In some embodiments, the unified display generates for display a visual stabilization indicator 1205 within the viewport to inform the user of ongoing system adjustments. During rapid head movements or transitions, the system displays subtle visual cues, such as, for example, a pulsing border or fading icon, to indicate stabilization progress.

In some embodiments, motion feedback arrows 1205 or motion vectors overlayed on the viewport can illustrate the direction and magnitude of recent head movements, helping the user maintain orientation. These indicators may enhance user confidence by providing feedback on system behavior without introducing distractions or discomfort.

In some embodiments, the unified display 1201 comprises a mini-map or wide-angle overlay within the viewport to improve user situational awareness. While the user engages in telephoto zoom, the mini-map displays a small inset view of the wide-angle passthrough scene, showing the user's position within the broader environment.

In some embodiments, the XR HMD allows toggling between the zoomed-in view 1207 and the wide-angle perspective 1204 using a simple interaction, providing quick context without interrupting the user's task.

In some embodiments, the unified display 1201 may dynamically highlight objects within the scene that are at the same depth as the user's current focal point. These depth highlights may be rendered as subtle outlines, brightness adjustments, or soft glows that differentiate objects aligned with the current depth of field from the rest of the scene. This feature may help the user visually parse complex scenes by emphasizing relevant objects and reducing distractions.

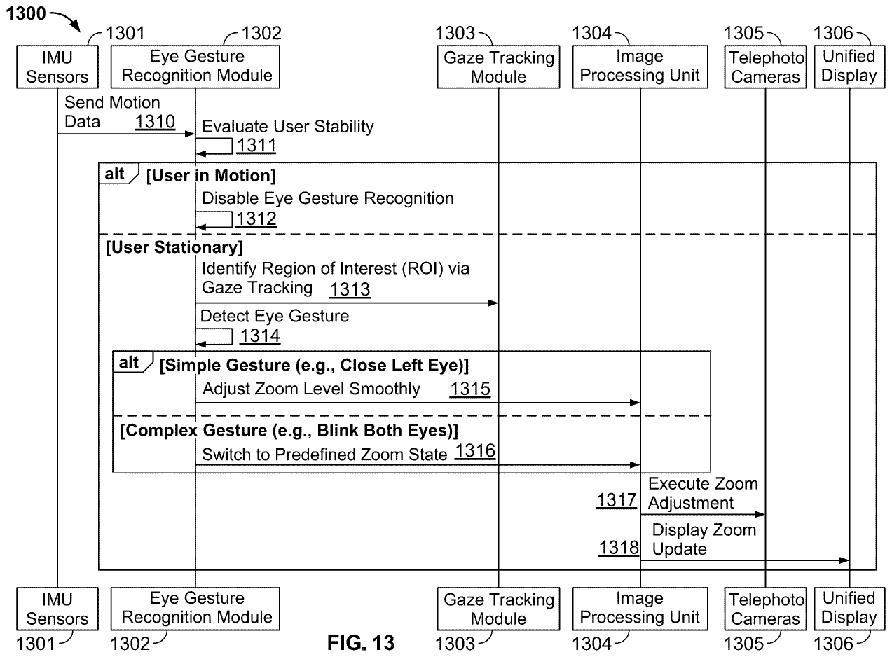

FIG. 13 depicts an illustrative block diagram and process 1300 for dynamic parallax correction and binocular zoom alignment of telephoto cameras in an XR HMD, in accordance with some embodiments of this disclosure. Building upon FIGS. 1-12 and 14-21, process 1300 integrates dynamic focus indicators within the viewport to guide the user's attention. For example, a reticle, dot, or small cursor aligns with the user's gaze or focal point, providing real-time feedback on the object being targeted and a motion-based fallback mechanism designed to prevent, minimize, or reduce user discomfort during rapid head movements while using zoomed telephoto views. The components listed and depicted in FIG. 13 may have the same or similar features to the components described above, and therefore the description of similar features is omitted for brevity. This indicator dynamically adjusts as the user shifts their gaze or zooms in on a region of interest.

In various embodiments, the individual steps of process 1300 may be implemented by one or more components of the computing devices, processes, and systems of FIGS. 1-12 and 14-21 may be performed in combination with any of the other processes and aspects described herein. Although the present disclosure may describe certain steps of process 1300 (and of other processes described herein) as being implemented by certain components of the computing devices, processes and systems of FIGS. 1-12 and 14-21, this is for purposes of illustration only. It should be understood that other components of the computing devices, processes, and systems of FIGS. 1-12 and 14-21 may implement those steps instead.

In some embodiments, the system allows users to lock onto a specific object of interest within the scene. Once locked, the system stabilizes the object in the viewport, even if the user moves their head slightly. This stabilization may try to ensure that the object remains centered and aligned, providing the user with a consistent view.

At 1310, the IMU sensor 1301 collects and sends motion data to the eye gesture recognition module 1302. At 1311, the eye gesture recognition module 1302 evaluates user stability. For example, module 1302 may be configured to employ any suitable sensors (e.g., an image sensor, IR sensors) to monitor the eyes of the user and determine whether the user is blinking, and/or a number of blinks over a certain period of time, and/or eyelid movements and/or any other suitable eye gesture.

In some embodiments, the user may be in motion. At 1312, the eye gesture recognition module 1302 may disable eye gesture recognition based on detected motion of the XR HMD. In other embodiments, the user may be stationary, that is the, XR HMD may detect (e.g., only) substantively small movements (e.g., under a specified threshold). At 1313, the eye gesture recognition module 1302 causes the gaze tracking module 1303 to identify an ROI. At 1314, the eye gesture recognition module 1302 detects eye gestures.

In some embodiments, an eye gesture is detected by inward-facing cameras on the XR HMD (e.g., closing one eye, blinking). At 1315, the eye gesture recognition module 1302 causes the image processing unit 1304 to adjust zoom levels. In some embodiments, an eye gesture is a complex eye gesture (e.g., blinking both eyes). At 1316, the eye gesture recognition module 1302 may recognize the complex eye gesture and cause the image processing unit 1304 to switch to predefined zoom state. At 1317, the image processing unit 1304 may cause the telephoto cameras 1305 to execute zoom adjustments. At 1318, the image processing unit 1304 may cause the unified display 1306 to display zoom updates.

In some embodiments, the system marks or remembers the object that the user had previously zoomed in on to make it easier to find that object again in a subsequent zooming session. For example, an indication of the object that the user previously zoomed in on may be stored in a data structure accessible by the XR device. If a user zoomed in on the top of a tall building, then the marker may be visible when the user zooms out to a wide-angle view. Interaction with the marker int the wide-angle view may trigger the previous zoom level and focus of the cameras to return to the same settings as when the marker was created.

In some embodiments, markers created by users may be shared among other users. For example if a user has shared a zoom marker of an architectural feature of a building, other users who enable zoom mode with markers may see the marker when they view the area near or when the building is visible to the system.

In some embodiments, the system dynamically adjusts the FOV during interactions to ensure a balanced and comfortable visual experience. For example, the FOV can expand when transitioning from telephoto to wide-angle views or contract when zooming in to a specific region of interest.

In some embodiments, the system enhances peripheral awareness by incorporating subtle visual indicators at the edges of the viewport. These indicators, such as, for example, pulsing lights or soft highlights, notify the user of obstacles, moving objects, or environmental changes outside the immediate field of view.

In some embodiments, the system includes a reorientation helper to guide users back to a stable view if they lose focus or move abruptly. For example, arrows or a soft spotlight in the viewport can direct the user's attention toward a stable orientation or region of interest. In some embodiments, the system provides a user preferences panel that allows users to customize visual aids within the viewport. Users can toggle features such as, for example, depth highlights, focus indicators, mini-maps, and zoom feedback based on their preferences or task requirements.

In some embodiments, the system integrates voice recognition to enable hands-free control of zoom and focus adjustments. The system uses a microphone array and a voice processing unit to detect and interpret user commands. For example, the user can say “Zoom in,” “Zoom out,” or “Focus on the marker” to adjust the telephoto cameras or change the region of interest, to cause the system to perform the uttered command.

In some embodiments, the system provides voice feedback for visual changes to enhance user awareness and confirmation. When a user issues a command, such as, for example, “Zoom in,” the system responds with audio feedback like “Zooming in by 2×” or “Focusing on target.” In some embodiments, the system includes gesture recognition to allow users to select and interact with ROIs. The system uses hand-tracking cameras or sensors to detect gestures such as, for example, pointing, tapping, or swiping. For example, a user can point at an object to zoom in on or swipe left to transition between wide-angle and telephoto views.

In some embodiments, the system provides gesture-based depth and zoom controls for precise adjustments. For example, a pinching gesture can zoom in or out, while an open-hand push gesture can reset the view to a default alignment. Depth adjustments can be made by a pulling or pushing motion, dynamically changing the focus depth.

In some embodiments, the system utilizes eye gestures to control zoom functionality, enabling hands-free and intuitive interaction. The system distinguishes between simple blinking and more complex eye gestures to trigger specific actions. For example, smoothly adjusting zoom levels, either zooming in or out when a user closes their left or right eye, may be identified and distinguished, e.g., based on user preferences. For example, when an instant switch between predefined zoom states, such as, for example, transitioning from a wide-angle view to a telephoto view or vice versa. A user may blink both eyes or blink an eye in a pattern.

In some embodiments, to prevent, minimize, or reduce unintentional activation, the system may activate eye gesture-based controls only when the user is standing still, as determined by IMU sensors. The system continuously monitors the user's stability and motion, and it may disable eye gesture recognition when the user is in motion, such as, for example, walking, jogging, running, biking, or the like.

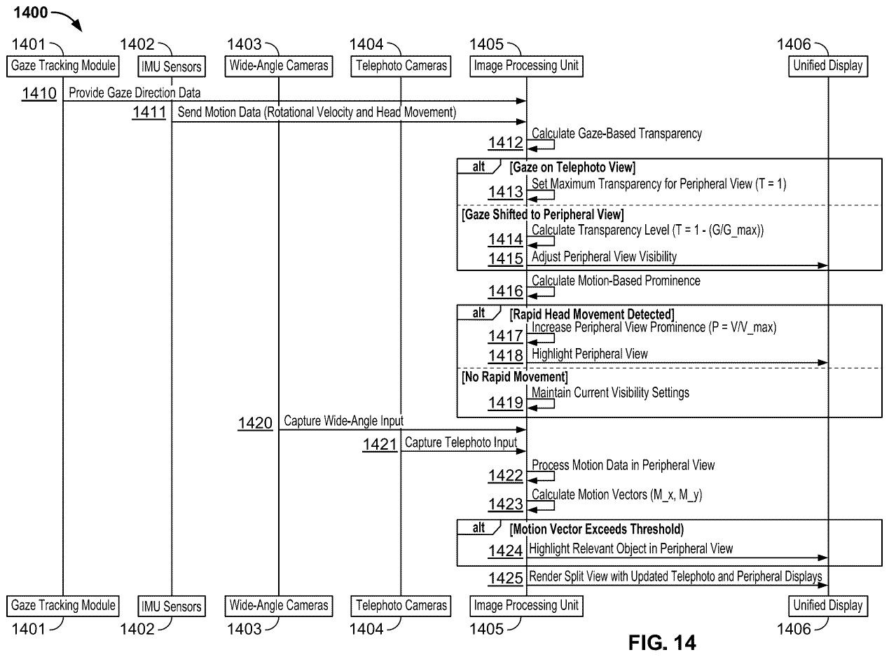

FIG. 14 depicts an illustrative block diagram and process 1400 for dynamic parallax correction and binocular zoom alignment of telephoto cameras in an XR HMD, in accordance with some embodiments of this disclosure. Building upon FIGS. 1-13 and 15-21, process 1400 provides for users to lock onto an object of interest using gestures. For example, the user can circle an object with their finger or make a tapping motion to lock the system onto that object. Once locked, the system stabilizes the object in the viewport, even if the user moves their head or shifts their gaze. The components listed and depicted in FIG. 14 may have the same or similar features to the components described above, and therefore the description of similar features is omitted for brevity.

In various embodiments, the individual steps of process 1400 may be implemented by one or more components of the computing devices, processes, and systems of FIGS. 1-13 and 15-21 may be performed in combination with any of the other processes and aspects described herein. Although the present disclosure may describe certain steps of process 1400 (and of other processes described herein) as being implemented by certain components of the computing devices, processes and systems of FIGS. 1-13 and 15-21, this is for purposes of illustration only. It should be understood that other components of the computing devices, processes, and systems of FIGS. 1-13 and 15-21 may implement those steps instead.

At 1410, the gaze tracking module 1401 provides gaze direction data to the image processing unit 1405. At 1411, the IMU sensors 1402 sends motion data (e.g., rotational velocity and head movement) to the image processing unit 1405. This may cause the image processing unit 1405, at 1412, to calculate gaze-based transparency.

In some embodiments, the gaze direction on the telephoto zoom is set at 1413 by the image processing unit 1405, the image processing unit 1405 may set maximum transparency for peripheral view (e.g., T=1). For example, the system may perform calculations to manage the split-view display effectively, and monitor the user's gaze direction and head motion using gaze tracking sensors and IMU data. If the user's gaze vector intersects with the central telephoto view, the system calculates the level of transparency required for the peripheral display based on the angular distance between the gaze vector and the peripheral regions. If the gaze is aligned directly with the telephoto view, the system might apply maximum transparency to the wide-angle display, represented as a value T=1.

At 1414, the image processing unit 1405 calculates transparency levels (e.g., T=1−(G/G_max)). At 1415, the image processing unit 1405 causes the unified display 1406 to adjust peripheral view visibility. At 1416, the image processing unit 1405 calculates motion-based prominence.

In some embodiments, when rapid head movement is detected, at 1417, the image processing unit 1405 may increase peripheral view prominence (e.g., P=V/V_max). At 1418, the image processing unit 1405 causes the unified display 1406 to highlight peripheral view.

In some embodiments, when no or substantively minimal head movement is detected, at 1419, the image processing unit 1405 may maintain current visibility settings.

At 1420, the wide-angle cameras 1403 captures and sends wide-angle input to the image processing unit 1405. At 1421, the telephoto cameras 1404 captures and sends telephoto input to the image processing unit 1405. At 1422, the image processing unit 1405 processes motion data in the peripheral view. At 1423, the image processing unit 1405 calculates motion vectors (Mx, My).

In some embodiments, the motion vector exceeds a threshold value designated on system of the image processing unit 1405, and, at 1424, the image processing unit 1405 causes the unified display to highlight relevant objects in peripheral view. At 1425, the image processing unit 1405 causes the unified display to render split view with update telephoto and peripheral displays.

In some embodiments, the process 1400 includes voice commands for safety and navigation assistance. Users can issue commands such as, for example, “Show my surroundings,” to activate the wide-angle passthrough view or “Highlight obstacles” to activate peripheral awareness indicators.

In some embodiments, the process 1400 integrates voice and gesture controls to provide multi-modal interaction capabilities. For example, the user can issue a voice command like “Focus here” while pointing to an object. The system processes the combined inputs to identify the ROI and adjust the view accordingly.

In some embodiments, the process 1400 visualizes multiple depth layers simultaneously, using semi-transparent overlays to distinguish objects at different depths. For example, objects closer to the user may appear more opaque, while distant objects are rendered in lighter shades or with reduced detail.

In some embodiments, the process 1400 enhances situational awareness by integrating a split-view mode that displays the wide-angle view in the peripheral regions of the viewport. The central portion of the display focuses on the zoomed-in telephoto view, while the wide-angle view is rendered as a semi-transparent overlay or peripheral band around the edges. This configuration allows users to maintain detailed focus on the zoomed region of interest while retaining awareness of their surroundings through the wide-angle perspective. The system dynamically adjusts the transparency and prominence of the wide-angle peripheral display based on user motion and gaze direction. If the user's gaze is locked on the telephoto view, the peripheral wide-angle display becomes more transparent, minimizing distractions and allowing the user to focus on fine details in the zoomed view. Conversely, if the user's motion, such as, for example, a rapid head turn, suggests broader situational awareness may be useful, the system increases the visibility of the wide-angle display. This adaptive behavior ensures that the system responds fluidly to the user's needs, balancing detailed focus with peripheral context.

In some embodiments, the split-view mode addresses the challenges of processing both central and peripheral visual information. Peripheral vision is optimized for detecting motion and general context but is less effective at resolving fine details. To reduce cognitive load, the peripheral wide-angle view emphasizes high-level contextual information, such as, for example, object motion or environmental changes, while avoiding, minimizing, or reducing unnecessary detail. For instance, the wide-angle display may use simplified representations, such as, for example, low-resolution imagery or blurred visuals, to provide spatial context without overwhelming the user. Motion within the peripheral view is highlighted only when relevant to the user's task, ensuring that events of interest, such as, for example, an approaching vehicle or moving pedestrian, are emphasized while irrelevant motion is suppressed.

In some embodiments, if the gaze shifts toward the peripheral regions, the transparency decreases, with values calculated dynamically as T=1−(G/G_max), where G is the angular distance of the gaze vector from the center of the telephoto view and G_max is a predefined threshold. Similarly, the system uses IMU data to detect rapid head movements, calculating the rotational velocity and angular displacement. If the rotational velocity exceeds a predefined threshold, the system increases the prominence of the peripheral wide-angle display, ensuring that the user has immediate access to situational context. The prominence level is calculated as a function of the detected velocity, P=(V/V_max), where V is the rotational velocity and V_max is the maximum velocity threshold.

In some embodiments, the process 1400 dynamic adaptation extends to highlighting motion within the peripheral view. The system identifies objects within the wide-angle camera's field of view and calculates their motion vectors based on positional changes over time. For an object moving between two frames, the motion vector components M_x and M_y are calculated as M_x=(X_2−X_1)/Δt and M_y=(Y_2−Y_1)/Δt, where X and Y are the object's coordinates and Δt is the time interval. If the magnitude of the motion vector exceeds a relevance threshold, the system highlights the object within the peripheral view using a visual indicator, such as, for example, a bright outline or trajectory overlay.

For example, a user navigating a busy urban environment may use the telephoto view to zoom in on a distant object, such as, for example, a traffic signal, while relying on the peripheral wide-angle display to monitor nearby activity, such as, for example, pedestrians or approaching vehicles. In another scenario, a user inspecting a distant structure may maintain detailed focus on specific components while remaining aware of surrounding obstacles or changes in the broader scene.

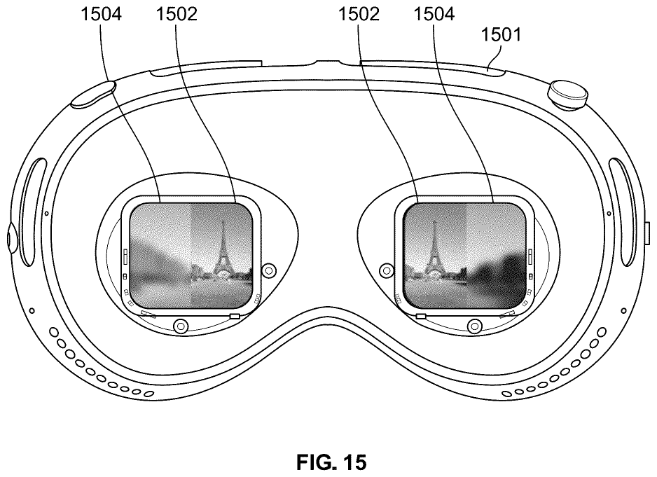

FIG. 15 depicts a rendering of an XR HMD 1501, in accordance with some embodiments of this disclosure. Building upon FIGS. 1-14 and 16-21, FIG. 15 provides an illustrative example of process 1400, showing peripheral wide-angle views 1504. The components listed and depicted in FIG. 15 may have the same or similar features to the components described above, and therefore the description of similar features is omitted for brevity.

In various embodiments, the unified display (e.g., 1504 and 1502) on the XR HMD 1501 may be implemented by one or more components of the computing devices, processes, and systems of FIGS. 1-14 and 16-21 may be performed in combination with any of the other processes and aspects described herein. Although the present disclosure may describe certain steps of process 1500 (and of other processes described herein) as being implemented by certain components of the computing devices, processes and systems of FIGS. 1-14 and 16-21, this is for purposes of illustration only. It should be understood that other components of the computing devices, processes, and systems of FIGS. 1-14 and 16-21 may implement those steps instead.

FIG. 15 depicts the unified display on the XR HMD 1501. The XR HMD 1501 displays on both left and right sides a wide-angle view 1504 and a telephoto view 1502.

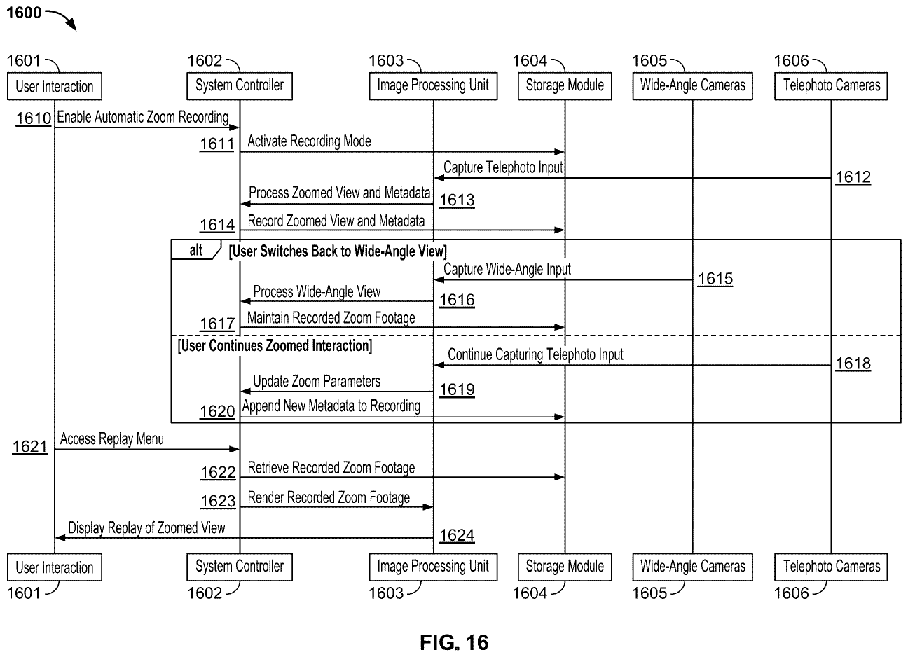

FIG. 16 depicts an illustrative block diagram and process 1600 for dynamic parallax correction and binocular zoom alignment of telephoto cameras in an XR HMD, in accordance with some embodiments of this disclosure. Building upon FIGS. 1-15 and 16-21, process 1600 provides smart zoom suggestions based on gaze patterns and scene analysis. For example, if the user frequently looks at a specific object or region, the system may display a non-intrusive prompt like “Would you like to zoom in on this area?”. In some embodiments, the system may prompt the user to zoom-in on an object of plurality of objects, e.g., in a gaze and/or FOV of the user. The components listed and depicted in FIG. 16 may have the same or similar features to the components described above, and therefore the description of similar features is omitted for brevity.

In various embodiments, the individual steps of process 1600 may be implemented by one or more components of the computing devices, processes, and systems of FIGS. 1-15 and 17-21 may be performed in combination with any of the other processes and aspects described herein. Although the present disclosure may describe certain steps of process 1600 (and of other processes described herein) as being implemented by certain components of the computing devices, processes and systems of FIGS. 1-15 and 17-21, this is for purposes of illustration only. It should be understood that other components of the computing devices, processes, and systems of FIGS. 1-15 and 17-21 may implement those steps instead.

A storage module (e.g., 1604), as used herein, may refer to a component integrated within an XR device configured to retain and manage data essential for its operation and user interaction. Such a module may encompass hardware elements disposed within the XR device, e.g., including non-volatile memory (e.g., flash memory or solid-state drives (SSDs)), and volatile memory (e.g., random-access memory (RAM)), to store diverse data types. In the context of this disclosure, the storage module may retain calibration data—e.g., intrinsic and extrinsic parameters of telephoto and wide-angle cameras—gaze tracking profiles tailored to user-specific interpupillary distances, and disparity maps generated during real-time processing. Additionally, the module may include temporary buffers for image frames, motion data from IMUs, and historical patterns used for predictive stabilization, ensuring rapid access during dynamic parallax correction and binocular zoom alignment.

In some embodiments, the storage module comprises embedded memory circuits coupled to the image processing unit, facilitating low-latency data retrieval for seamless transitions between wide-angle and telephoto views, while in other embodiments, it may incorporate removable storage media, such as, for example, secure digital (SD) cards, to expand capacity or enable data transfer.

In some embodiments, the storage module extends its functionality to cloud-based storage, wherein data—such as, for example, historical motion patterns, user-specific calibration settings, or processed disparity maps—is transmitted via a network interface to remote servers, enabling persistent storage, expanded capacity, and retrieval for seamless operation across sessions or devices, complementing onboard memory with low-latency access during telephoto and wide-angle view transitions.

At 1610, the user interaction 1601 is received by the XR HMD instructing the system controller 1602 to enable automatic zoom recording. At 1611, the system controller 1602 causes the storage module 1604 to activate recording and store data. At 1612, the telephoto cameras 1606 captures telephoto input and sends it to the image processing unit 1603, which causes the image processing unit 1603, at 1613, to process zoomed view (e.g., zoomed-in view or zoomed-out view in relation to a prior zoom level) and metadata to the system controller 1602. At 1614, the system controller 1602 records the zoomed view and metadata and transmits it to the storage module 1604.

In some embodiments, the user may switch back from telephoto view to wide-angle view, and at 1615, wide-angle cameras 1605 captures wide-angle input and transmits the input to the image processing unit 1603. At 1616, the image processing unit 1603 causes the system controller 1602 to process the wide-angle view. At 1617, the system controller 1602 maintains recorded zoom footage and transmits it to the storage module 1604.

In some embodiments, the user continues zoomed interactions, and, at 1618, the telephoto cameras 1606 continues capturing telephoto input and transmits the input to the image processing unit 1603. At 1619, the image processing unit 1603 causes the system controller 1602 to update zoom parameters. At 1620, the system controller 1602 appends new metadata to recording and transmits the data to the storage module 1604.

At 1621, the user interaction 1601 causes the system controller 1602 to access the replay menu. At 1622, the system controller 1602 retrieves recorded zoom footage from the storage module 1604 and at 1623, the system controller 1602 causes the image processing unit 1603 to render recorded zoom footage. At 1624, the image processing unit 1603 causes display of a replay of the zoomed view, based at least in part on the user interaction 1601.

In some embodiments, the process 1600 includes an automatic zoom recording feature that, when enabled via user preferences, continuously records zoomed views and interactions for later replay. This feature allows users to revisit and analyze their zoomed footage at any time. The system records not only the visual context of the zoomed views but also the regions of interest (ROIs) and associated zoom parameters. The system operates in the background when the feature is activated, recording the zoomed footage and relevant metadata such as, for example, depth, zoom level, and gaze-or motion-based adjustments. If the user zooms in to examine a specific object and quickly switches back to the standard wide-angle view, the system preserves the zoomed footage for later access.

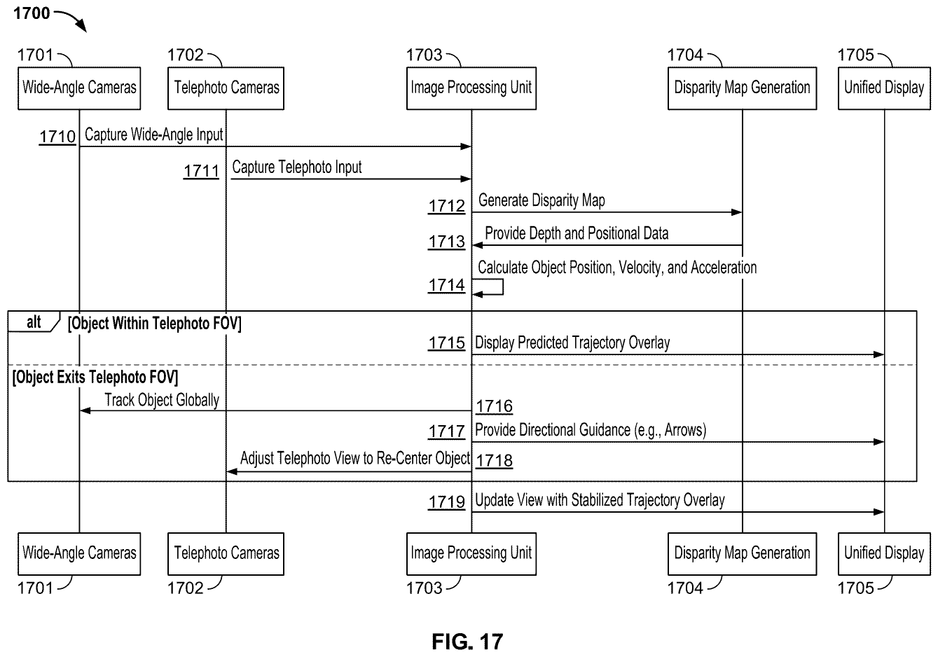

FIG. 17 depicts an illustrative block diagram and process 1700 for dynamic parallax correction and binocular zoom alignment of telephoto cameras in an XR HMD, in accordance with some embodiments of this disclosure. Building upon FIGS. 1-16 and 17-21, process 1700 provides for predicting the path of a moving object, such as, for example, an aerial vehicle (e.g., a drone or any other suitable aerial vehicle), unmanned aerial vehicle (e.g., a drone) or other vehicle (e.g., an automobile, a boat, aircraft, bicycle, or any other suitable vehicle), and overlays a dynamic trajectory within the zoomed-in viewport. The components listed and depicted in FIG. 17 may have the same or similar features to the components described above, and therefore the description of similar features is omitted for brevity.

In various embodiments, the individual steps of process 1700 may be implemented by one or more components of the computing devices, processes, and systems of FIGS. 1-16 and 18-21 may be performed in combination with any of the other processes and aspects described herein. Although the present disclosure may describe certain steps of process 1700 (and of other processes described herein) as being implemented by certain components of the computing devices, processes and systems of FIGS. 1-16 and 18-21, this is for purposes of illustration only. It should be understood that other components of the computing devices, processes, and systems of FIGS. 1-16 and 18-21 may implement those steps instead.

Process 1700 begins with 1710. At 1710, the wide-angle camera(s) 1701 capture(s) wide-angle input and transmits the input to the image processing unit 1703. At 1711 the telephoto cameras 1702 captures telephoto input and transmits the input to the image processing unit 1703. At 1712, the image processing unit 1703 causes the disparity map generation 1704 to generate a disparity map. At 1713, the image processing unit 1703 receives depth and positional data, and at 1714 the image processing unit 1703 calculates object position, velocity, and acceleration.

In some embodiments, the object may be detected within the telephoto FOV, causing the image processing unit 1703, at 1715, to display predicted trajectory overlay on the unified display 1705.

In some embodiments, the object exits the telephoto FOV and, at 1716, causes the image processing unit 1703, at 1716, to track the object globally by the wide-angle cameras 1701. At 1717 the image processing unit 1703 provides direction guidance (e.g., virtual display of arrows) to the unified display 1705. At 1718, the image processing unit 1703 causes the telephoto camera to adjust view to recenter the object within its FOV. At 1719, the image processing unit 1703 causes the unified display 1705 to update the view with stabilized trajectory overlay.

Process 1700 addresses challenges unique to telephoto zoom, such as, for example, a restricted FOV, magnified motion effects, and limited depth perception. By leveraging inputs from the wide-angle 1701 cameras alongside the telephoto view, the system ensures seamless tracking and trajectory prediction, even when the object exits the zoomed FOV. The system uses wide-angle cameras 1701 to continuously monitor the entire scene, capturing the global position and motion of the object. This data is mapped to the telephoto view using depth and positional information derived from the disparity map. While the zoomed view provides detailed focus on the object, the wide-angle cameras 1701 act as a backup tracker, ensuring that the object remains consistently monitored even if it leaves the zoomed FOV.

In some embodiments, process 1700 provides for and identifies the object of interest within the scene and uses its position, velocity, and acceleration to estimate its future trajectory. For example, the estimates of the position, velocity, and acceleration of a moving object are calculated in a standard way using data from the cameras and the disparity map. The disparity map provides the relative horizontal or vertical offset between corresponding points in the left and right images. Using the disparity d, the system calculates the depth Z, or distance to the object, using the relationship Z=(f*D₀)/d, where f is the focal length of the camera, D₀ is the interpupillary distance, and d is the disparity value.

Continuing the example, to determine the 3D coordinates of the object in camera space, the depth Z is combined with the 2D image coordinates (x, y) of the object and the camera's principal point offsets (cₓ, c_{γ}), yielding the following: X=((x−cₓ)*Z)/f and Y=((y−c_{γ})*Z)/f, where X, Y, and Z represent the object's position in 3D space. The velocity of the object is estimated by tracking the change in its position over time. By comparing the object's position at two consecutive time intervals t₁ and t₂, the velocity components Vₓ, V_{γ}, and V are calculated as: Vₓ=(X₂−X₁)/(t₂−t₁), V_{γ}=(Y₂−Y₁)/(t₂−t₁), and V=(Z₂−Z₁)/(t₂−t₁). These values give the velocity vector (Vₓ, V_{γ}, V) , which describes the speed and direction of the object's motion.

In some embodiments, the system then calculates the acceleration of the object by analyzing how its velocity changes between two successive time intervals t₁ and t₂. The acceleration components Aₓ, A_{γ}, and A are computed as: Aₓ=(Vₓ₂−Vₓ₁)/(t₂−t₁), A_{y}=(V_{γ2}−V_{γ1})/(t₂−t₁), and A=(V₂−V₁)/(t₂−t₁). This yields the acceleration vector (Aₓ, A_{γ}, A), which reflects how the object's motion is changing over time.

In some embodiments, the predicted path is displayed as a dynamic overlay within the zoomed viewport, with the trajectory length and resolution adapting to the zoom level to minimize clutter. For example, in highly magnified views, the overlay may prioritize short-term, precise predictions, while in broader views, it may extend farther into the object's projected path.

In some embodiments, the object may be determined to have moved outside the telephoto FOV, and the wide-angle cameras may continue to track its motion. The system then provides directional guidance within the zoomed view, such as, for example, arrows or subtle indicators at the edges of the viewport, to help the user re-center the object. Additionally, the system can automatically adjust the telephoto cameras to follow the object's trajectory, re-centering the view to keep the object in focus.

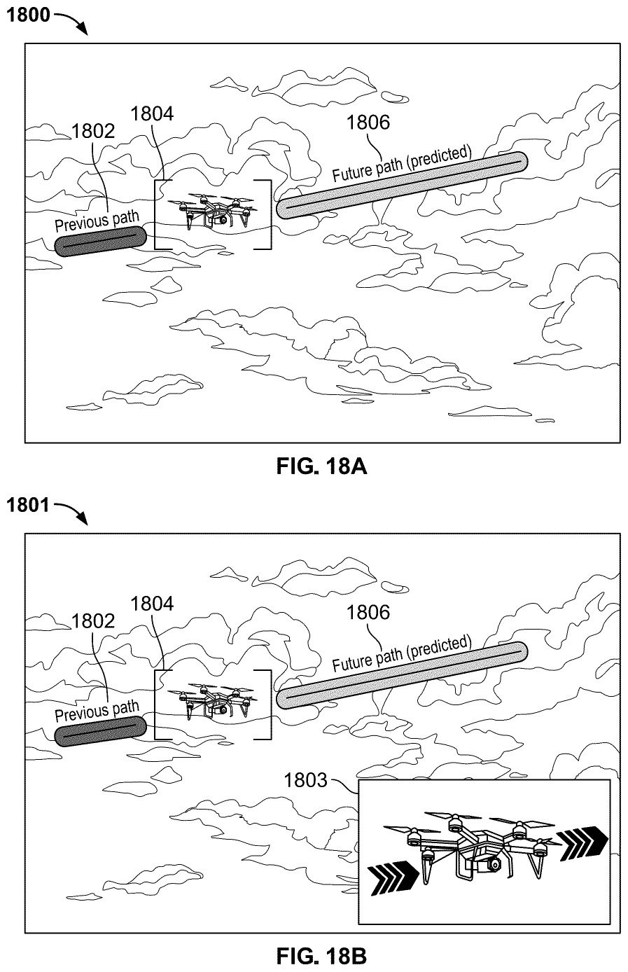

FIGS. 18A-18B depict a rendering of a unified display (e.g., 1800 and 1801) on an XR HMD, in accordance with some embodiments of this disclosure. Building upon FIGS. 1-17 and 19-21, FIGS. 18A-18B provide a rendering example of process 1700, what a user may see on a unified display to predict the path of a moving objects (e.g., a drone or vehicle). The components listed and depicted in FIGS. 18A-18B may have the same or similar features to the components described above, and therefore the description of similar features is omitted for brevity.

In various embodiments, the unified display (e.g., 1800 and 1801) on the XR HMD may be implemented by one or more components of the computing devices, processes, and systems of FIGS. 1-17 and 19-21 may be performed in combination with any of the other processes and aspects described herein. Although the present disclosure may describe certain steps of process 1700 (and of other processes described herein) as being implemented by certain components of the computing devices, processes and systems of FIGS. 1-17 and 19-21, this is for purposes of illustration only. It should be understood that other components of the computing devices, processes, and systems of FIGS. 1-17 and 19-21 may implement those steps instead. In some embodiments, the arrows added in the insert (e.g., adjacent to drone at 1804 in FIG. 18B) may be derived from the previous and computed path above and may be inserted to allow the user to still track the object. This may be useful, for example, when the telephoto lenses are not mechanized and the only way to track in telephoto may be to move one's head.

FIG. 18A depicts an example of a user interface 1800 (e.g., unified display) showing a wide-angle view of a scene, tracking a moving object (e.g., drone). As described in process 1700, an indicator (e.g., virtual frame 1804) may surround the moving object, and append to the moving object a virtual path (e.g., previous path 1802 and predicted future path 1806).

FIG. 18B depicts an example of a user interface 1801 (e.g., unified display) showing the same view as FIG. 18A but with the user zooming in on the moving object (e.g., 1803).

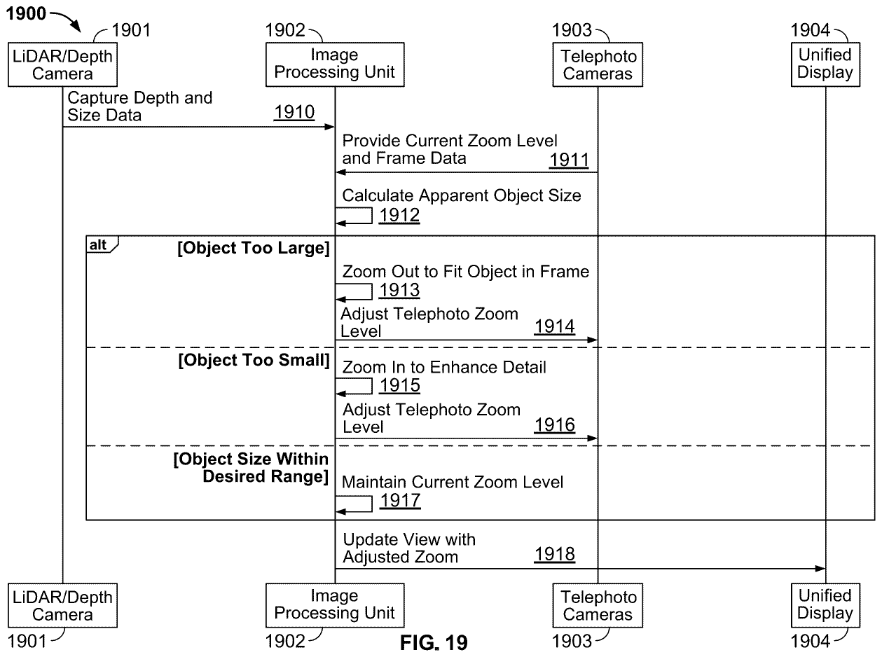

FIG. 19 depicts an illustrative block diagram and process 1900 for dynamic parallax correction and binocular zoom alignment of telephoto cameras in an XR HMD, in accordance with some embodiments of this disclosure. Building upon FIGS. 1-18 and 20-21, process 1900 provides for dynamically adjusting the zoom level of the telephoto camera based on the user's pace and movement direction relative to an object of interest. The components listed and depicted in FIG. 19 may be have the same or similar features to the components described above, and therefore the description of similar features is omitted for brevity.

In various embodiments, the individual steps of process 1900 may be implemented by one or more components of the computing devices, processes, and systems of FIGS. 1-18, 20, and 21 may be performed in combination with any of the other processes and aspects described herein. Although the present disclosure may describe certain steps of process 1900 (and of other processes described herein) as being implemented by certain components of the computing devices, processes and systems of FIGS. 1-18, 20, and 21, this is for purposes of illustration only. It should be understood that other components of the computing devices, processes, and systems of FIGS. 1-18, 20, and 21 may implement those steps instead.

In some embodiments, process 1900 tracks objects in a scene by leveraging motion detection sensors, including accelerometers to measure the user's pace, gyroscopes to track orientation, GPS for spatial positioning, and/or LiDAR to calculate the distance to the object the user is gazing at or moving toward. In some embodiments, by integrating this data, the system determines whether the user is moving closer to or away from the object and adjusts the zoom level accordingly. For example, if the system detects the user is walking towards an object of interest, such as, for example, a landmark, at a consistent pace, the system smoothly zooms out to maintain a stable field of view as the object's apparent size increases.

Process 1900 begins with 1910. At 1910, a LiDAR sensor and/or depth camera 1901 captures sensor data, e.g., the depth and size data of a detectable moving or stationary object and sends the data to an image processing unit 1902. At 1911, the telephoto cameras 1903 provides the image processing unit 1902 zoom levels and frame data. At 1912, the image processing unit 1902 uses the data to calculate apparent object size.

In some embodiments, the object may be detected as too large, at 1913, and cause the image processing unit 1902 to cause the telephoto cameras 903 to zoom out to fit the object in frame. At 1914, the image processing unit 1902 causes the telephoto zoom levels to adjust on the telephoto cameras 1903.

In some embodiments, the object may be detected to be too small (e.g., below a threshold size), at 1915, causing the image processing unit 1902 to zoom in and enhance detail. At 1916, the image processing unit 1902 causes the telephoto cameras 1903 to adjust telephoto zoom level.

In some embodiments, the object may be detected to be within desired range, at 1917, causing the image processing unit 1902 to maintain current zoom levels. At 1918, the image processing unit 1902 causes the unified display to update view with the adjected zoom level.

In some embodiments, process 1900 leverages motion detection sensors, including accelerometers to measure the user's pace, gyroscopes to track orientation, GPS for spatial positioning, and/or LiDAR to calculate the distance to the object the user is gazing at or moving toward. By integrating this data, the system determines whether the user is moving closer to or away from the object and adjusts the zoom level accordingly. For example, the system may determine, based on sensor data captured by the sensor, a distance between the XR apparatus and an object in an ROI, and may cause the telephoto camera to capture a zoomed-in view of the ROI at a zoom level. If the system detects the user is walking towards an object of interest, such as, for example, a landmark, at a consistent pace, it smoothly zooms out to maintain a stable field of view as the object's apparent size increases. Conversely, if the system determines or detects the user is moving away from the object, the system zooms in to help maintain a detailed view of the object within the frame. The zoom level may be calculated based on both the user's speed and distance from the object, stabilizing the transition to prevent, minimize, or reduce abrupt changes. For instance, the system may apply a formula like Zoom Level=Z₀±(k*Speed), where Z₀ is the initial zoom level, k is a scaling factor, and Speed is the user's walking or running speed. The system may incorporate a distance and speed threshold to activate zoom adjustments. If the user's pace falls below a predefined threshold, indicating they are standing still or moving slowly, the system may maintain the current zoom level or zoom in further to provide more detail. For example, when the user stops in front of a statue, the system automatically zooms in to highlight intricate details. Alternatively, the system may stabilize the current zoom level in response to a user command, ensuring no further changes occur until explicitly overridden.

In some embodiments, the zoom lenses may provide a narrower FOV for detailed examination of objects, while the normal lenses may offer a broader FOV for situational awareness. A challenge arises when a zoomed-in object moves out of the zoom lens's narrow FOV and into the normal lens' broader FOV. To help address this, in some embodiments, one or more of the following techniques may be employed:
1) The zoom lens/camera, if possible, dynamically adjusts its orientation to track the object, maintaining the zoomed-in view; it may be desirable for the telephoto lenses to be fully actuated so that they can point to any direction without requiring the user to move their head.
2) If the telephoto lens is not actuated, the XR device may detect that an object has left the telephoto FOV and instruct the user to shift their head to realign the headset's zoom lens FOV with the object, enabling continued tracking through the zoom lens; and
3) The system digitally zooms into the normal lens's image to simulate the zoom lens' level, ensuring a seamless transition. In some embodiments, the system can enhance its digital zoom presentation by leveraging portion of the object or previous images of the object captured by the telephoto lens for improved detail; or gradually resizing the object to normalize its appearance to the image captured by normal lens as it moves farther away from the zoom lens' FOV.

In some embodiments, process 1900 ensures a fluid and intuitive viewing experience in diverse tracking scenarios. In another example, the XR device may be fitted with fully actuated telephoto cameras allowing them to focus on any point in the wide-angle camera's FOV. The actuated telephoto cameras may continuously scan the entirety of the wide-angle camera FOV over a short period of time, autonomously pointing their focus to multiple elements of the scene captured by the wide-angle camera. A user may then instruct the XR device to track and zoom one or more objects in the scene and the headset may use the information provided during the telephoto scan to generate inserts to track these elements, even though the user is not pointing their gaze towards them. This solves the problem of tracking multiple objects in a scene using a single dual-camera telephoto. The scanning of the scene by the telephoto cameras may include both pointing the cameras' focus to one direction as well as selecting varying magnification levels. The scanning period can be a few seconds depending on how fast the telephoto actuators operate for both tracking and zooming.

In some embodiments, the system considers the apparent size of the object within the frame when determining the zoom level. This ensures that the object remains within a desired range of the viewport, regardless of changes in the user's distance or orientation. Using input from LiDAR or depth-sensing cameras, the system calculates the object's size in real time and compares it to a target size range. If the object becomes too large, the system zooms out to fit it within the frame. If the object appears too small (e.g., below a threshold size), the system zooms in to enhance detail.

For example, if the user is observing a moving vehicle, the system dynamically adjusts the zoom level to ensure the vehicle occupies a consistent percentage of the frame, such as, for example, 20-30% of the viewport. This adjustment is based on the relationship between the object's real-world size, its distance from the user, and the current zoom level, calculated as Apparent Size=(Real Size×Zoom Level)/Distance. By keeping the apparent size within the predefined range, the system provides a visually balanced and contextually relevant view of the object.

FIGS. 20-21 describe illustrative devices, systems, servers, and related hardware for generating for display AR and VR images, in accordance with some embodiments of the present disclosure. FIG. 20 shows generalized embodiments of illustrative user equipment 2000 and 2001, which may correspond to, e.g., XR HMD 102 of FIG. 1. For example, user equipment 2000 may be a smartphone device, a tablet, a near-eye display device, an XR device, or any other suitable device capable of participating in an XR environment, e.g., locally or over a communication network. In another example, user equipment 2001 may be a user television equipment system or device. User equipment 2001 may include XR device (e.g., HMD) 2015. XR device 2015 may be communicatively connected to microphone 2016, audio output equipment 2014 (e.g., speaker or headphones), and display 2012. In some embodiments, microphone 2016 may receive audio corresponding to a voice of a user and/or ambient audio data. In some embodiments, display 2012 may be a television display, XR display, or a computer display. In some embodiments, XR device 2015 may be communicatively connected to user input interface 2010. In some embodiments, user input interface 2010 may be a remote-control device. XR device 2015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment are discussed below in connection with FIG. 21. In some embodiments, user equipment 2000 may comprise any suitable number of sensors (e.g., gyroscope or gyrometer, or accelerometer, etc.), and/or a GPS module (e.g., in communication with one or more servers and/or cell towers and/or satellites) to ascertain a location of user equipment 2000. In some embodiments, user equipment 2000 comprises a rechargeable battery that is configured to provide power to the components of the device.

Each one of user equipment 2000 and user equipment 2001 may receive content and data via input/output (I/O) path 2002. I/O path 2002 (e.g., an I/O circuitry for handling input and output signals) may provide content (e.g., broadcast programming, on-demand programming, internet content, content available over a local area network (LAN) or wide area network (WAN), and/or other content) and data to control circuitry 2004, which may comprise processing circuitry 2006 and storage 2008. Control circuitry 2004 may be used to send and receive commands, requests, and other suitable data using I/O path 2002, which may comprise I/O circuitry. I/O path 2002 may connect control circuitry 2004 to one or more communications paths (described below). I/O functions may be provided by one or more of these communications paths but are shown as a single path in FIG. 20 to avoid overcomplicating the drawing. While XR device 2015 is shown in FIG. 20 for illustration, any suitable computing device having processing circuitry, control circuitry, and storage may be used in accordance with the present disclosure. For example, XR device 2015 may be replaced by, or complemented by, a personal computer (e.g., a notebook, a laptop, a desktop), a smartphone (e.g., user equipment 2000), an XR device, a tablet, a network-based server hosting a user-accessible client device, a non-user-owned device, any other suitable device, or any combination thereof.

Control circuitry 2004 may be based on any suitable control circuitry such as, for example, processing circuitry 2006. As referred to herein, control circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 2004 executes instructions for the system (as described in connection with FIGS. 1-19) stored in memory (e.g., storage 2008). Specifically, control circuitry 2004 may be instructed by the system to perform the functions discussed above and below. In some implementations, processing or actions performed by control circuitry 2004 may be based on instructions received from the system.

In client/server-based embodiments, control circuitry 2004 may include communications circuitry suitable for communicating with a server or other networks or servers. The system may be a stand-alone application implemented on a device or a server. The application may be implemented as software or a set of executable instructions. The application may be the XR application described in FIG. 1. The instructions for performing any of the embodiments discussed herein of the application may be encoded on non-transitory computer-readable media (e.g., a hard drive, random-access memory on a dynamic random-access memory (DRAM) integrated circuit, read-only memory on a BLU-RAY disk, etc.). For example, in FIG. 20, the

In some embodiments, the application may be a client/server application where only the client application resides on user equipment 2000, and a server application resides on an external server (e.g., server 2104 and/or media content source 2102). For example, the application may be implemented partially as a client application on control circuitry 2004 of user equipment 2000 and partially on server 2104 as a server application running on control circuitry 2111. Server 2104 may be a part of a local area network with one or more of user equipment 2000, 2001 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 2104 and/or an edge computing device), referred to as “the cloud.” User equipment 2000 may be a cloud client that relies on the cloud computing capabilities from server 2104 to generate personalized engagement options in a VR or AR environment.

Control circuitry 2004 may include communications circuitry suitable for communicating with a server, edge computing systems and devices, a table or database server, or other networks or servers. The instructions for carrying out the above-mentioned functionality may be stored on a server (which is described in more detail in connection with FIG. 21). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 21). In addition, communications circuitry may include circuitry that enables peer-to-peer communication of user equipment, or communication of user equipment in locations remote from each other (described in more detail below).

Memory may be an electronic storage device provided as storage 2008 that is part of control circuitry 2004. As referred to herein, the phrase “electronic storage device” or “storage device” should be understood to mean any device for storing electronic data, computer software, or firmware, such as, for example, random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage 2008 may be used to store various types of content described herein as well as application data described above. Nonvolatile memory may also be used (e.g., to launch a boot-up routine and other instructions). Cloud-based storage, described in relation to FIG. 20, may be used to supplement storage 2008 or instead of storage 2008. Non-transitory memory may store instructions that, when executed by control circuitry, I/O circuitry, any other suitable circuitry or combination thereof, executes functions of an application as described above.

Control circuitry 2004 may include video generating circuitry and tuning circuitry, such as, for example, one or more analog tuners, one or more MPEG-2 decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 2004 may also include scaler circuitry for upconverting and downconverting content into the preferred output format of user equipment 2000. Control circuitry 2004 may also include digital-to-analog converter circuitry and analog-to-digital converter circuitry for converting between digital and analog signals. The tuning and encoding circuitry may be used by user equipment 2000, 2001 to receive and to display, to play, or to record content. The tuning and encoding circuitry may also be used to receive video communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 2008 is provided as a separate device from user equipment 2000, the tuning and encoding circuitry (including multiple tuners) may be associated with storage 2008.

Control circuitry 2004 may receive instruction from a user by way of user input interface 2010. User input interface 2010 may be any suitable user interface, such as, for example, a remote control, mouse, trackball, keypad, keyboard, touch screen, touchpad, stylus input, joystick, voice recognition interface, sensor interface (e.g., to track body movement, eye gaze, biometric parameters, etc.), or other user input interfaces. Display 2012 may be provided as a stand-alone device or integrated with other elements of each one of user equipment 2000 and user equipment 2001. For example, display 2012 may be a touchscreen or touch-sensitive display. In such circumstances, user input interface 2010 may be integrated with or combined with display 2012. In some embodiments, user input interface 2010 includes a remote-control device having one or more microphones, buttons, keypads, touchscreens, sensors, or any other components configured to receive user input or combinations thereof. For example, user input interface 2010 may include a handheld remote-control device having an alphanumeric keypad and option buttons. In a further example, user input interface 2010 may include a handheld remote-control device having a microphone and control circuitry configured to receive and identify voice commands and transmit information to XR device 2015.

Audio output equipment 2014 may be integrated with or combined with display 2012. Display 2012 may be one or more of a monitor, television, transparent display, liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 2012. Audio output equipment 2014 may be provided as integrated with other elements of each one of user equipment 2000 and user equipment 2001 or may be stand-alone units. An audio component of videos and other content displayed on display 2012 may be played through speakers (or headphones) of audio output equipment 2014. In some embodiments, audio may be distributed to a receiver (not shown), which processes and outputs the audio via speakers of audio output equipment 2014. In some embodiments, for example, control circuitry 2004 is configured to provide audio cues to a user, or other audio feedback to a user, using speakers of audio output equipment 2014. There may be a separate microphone 2016, or audio output equipment 2014 may include a microphone configured to receive audio input such as, for example, voice commands or speech. For example, a user may speak letters or words that are received by the microphone and converted to text by control circuitry 2004. In a further example, a user may speak voice commands that are received by a microphone and recognized by control circuitry 2004. Camera 2018 may be any suitable video camera integrated with the equipment or externally connected. Camera 2018 may be a digital camera comprising a CCD and/or a CMOS image sensor. Camera 2018 may be an analog camera that converts to digital images via a video card. Camera 2018 may be a transparent image sensor. For example, an XR device may use a transparent image sensor to capture a user's gestures, track a user's eye movements, or capture a user's facial expressions in relation to the VR or AR environment that are received by a transparent image sensor (or detector) and recognized by control circuitry 2004.

In some embodiments, user equipment 2001 may include biometric sensors, environmental sensors, motion sensors, depth sensors, gyroscopes, accelerometers, magnetometers, or any other suitable sensor or combination of such sensors (not shown). For example, an XR HMD device may use a biometric sensor to capture a user's heart rate, speech pattern, galvanic skin response, brain waves, body posture, etc., in relation to the VR or AR environment that are received by a biometric sensor and recognized by control circuitry 2004. For example, an XR HMD device may use an environmental sensor to capture ambient noise, ambient temperature, ambient light (including at least, visible and infrared light), proximate objects, etc., in relation to the VR or AR environment that are received by an environmental sensor and recognized by control circuitry 2004. For example, an XR HMD device may use motion sensors, depth sensors, gyroscopes, accelerometers, and/or magnetometers to capture a movement of the users, to track relationship aspects (such as, for example, direction, distance, etc.) within their actual environment, etc., in relation to the VR or AR environment that are received by a motion sensor, depth sensor, gyroscope, accelerometer, and/or magnetometer and recognized by control circuitry 2004.

The application may be implemented using any suitable architecture. For example, it may be a stand-alone application wholly implemented on each one of user equipment 2000 and user equipment 2001. In such an approach, instructions of the application may be stored locally (e.g., in storage 2008), and data for use by the application is downloaded on a periodic basis (e.g., from an out-of-band feed, from an internet resource, or using another suitable approach). Control circuitry 2004 may retrieve instructions of the application from storage 2008 and process the instructions to provide video conferencing functionality and generate any of the displays

FIG. 20 depicts illustrative devices, systems, servers, and related hardware for adjusting imagery captured by an XR device based on captured images, in accordance with some embodiments of this disclosure. User equipment 2000 and user equipment 2001 shown in FIG. 20 may include any type of user equipment configured to perform the functions described herein (e.g., XR HMD device 102 of FIG. 1 or any other suitable device configured to adjust captured imagery based on captured images). In some embodiments, user equipment 2000 and user equipment 2001 may be portable devices (e.g., mobile phones, tablets, still or video cameras equipped with suitable hardware and software for XR applications, including XR applications, etc.). User equipment 2000 and user equipment 2001 may be configured with suitable hardware and software to facilitate XR experiences. User equipment 2000 may include control circuitry 2004, an I/O path 2008 (which may comprise I/O circuitry), speaker 2006, display 2012, and user input interface 2010. In some embodiments, control circuitry 2004 may include processing circuitry 2006 and storage 2008 (e.g., RAM, ROM, hard disk, removable disk, etc.). In some embodiments, control circuitry 2004 may include one or more of each of a video processor, a GPU, and/or any suitable processing circuitry configured to facilitate XR applications utilizing XR technology. Control circuitry 2004 may execute an application stored in memory (e.g., storage 2008) that facilitates the functions of user equipment 2000 and user equipment 2001 described herein. Control circuitry 2004 may process instructions stored in storage 2008 for execution of the application and functionalities discussed herein. Based on the processed instructions, control circuitry 2004 may determine what action to perform when input is received from user input interface 2010. For example, movement of a cursor on a display up/down may be indicated by the processed instructions when user input interface 2010 indicates that an up/down button was selected. In a further example, user gestures, eye movements, or facial expressions may be indicated by the processed instructions when user input interface 2010 indicates that a user interacted with a VR or AR object. In a further example, user's biometrics, movement of the users, environmental inputs, etc., may be indicated by the processed instructions when user input interface 2010 indicates that a user interacted with a VR or AR object. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as, for example, a hard disk, floppy disk, USB drive, DVD, CD, media card, register memory, processor cache, random-access memory (RAM), etc.

Control circuitry 2004 may allow a user to provide user profile information or may automatically compile user profile information. For example, control circuitry 2004 may access and monitor network data, video data, audio data, processing data, content consumption data, and/or any other suitable data being accessed by a first user (e.g., first user 101 of the XR HMD device 102). Control circuitry 2004 may obtain all or part of other user profiles that are related to a particular user (e.g., via social media networks), and/or obtain information about the user from other sources that control circuitry 2004 may access. As a result, a user can be provided with a unified experience across the user's different devices.

In some embodiments, the application is a client/server-based application. Data for use by a thick or thin client implemented on each one of user equipment 2000 and user equipment 2001 may be retrieved on demand by issuing requests to a server remote from each one of user equipment 2000 and user equipment 2001. For example, the remote server may store the instructions for the application in a storage device. The remote server may process the stored instructions using circuitry (e.g., control circuitry 2004) and generate the displays discussed above and below. The client device may receive the displays generated by the remote server and may display the content of the displays locally on user equipment 2000. This way, the processing of the instructions is performed remotely by the server while the resulting displays (e.g., that may include text, a keyboard, or other visuals) are provided locally on user equipment 2000. User equipment 2000 may receive inputs from the user via user input interface 2010 and transmit those inputs to the remote server for processing and generating the corresponding displays. For example, user equipment 2000 may transmit a communication to the remote server indicating that an up/down button was selected via user input interface 2010. In a further example, user equipment 2000 may transmit a communication to the remote server indicating that a user interacted with a VR or AR object via user input interface 2010. The remote server may process instructions in accordance with that input and generate a display of the application corresponding to the input (e.g., a display that moves a cursor up/down). The generated display is then transmitted to user equipment 2000 for presentation to the user.

In some embodiments, the application may be downloaded and interpreted or otherwise run by an interpreter or virtual machine (run by control circuitry 2004). In some embodiments, the application may be encoded in the ETV Binary Interchange Format (EBIF), received by control circuitry 2004 as part of a suitable feed, and interpreted by a user agent running on control circuitry 2004. For example, the application may be an EBIF application. In some embodiments, the application may be defined by a series of JAVA-based files that are received and run by a local virtual machine or other suitable middleware executed by control circuitry 2004. In some of such embodiments (e.g., those employing MPEG-2, MPEG-4, HEVC or any other suitable digital media encoding schemes), the application may be, for example, encoded and transmitted in an MPEG-2 object carousel with the MPEG audio and video packets of a program.

As shown in FIG. 21, user equipment 2106, 2107, 2108, 2110 (which may correspond to user equipment, e.g., XR HMD device 102 of FIG. 1) may be coupled to communication network 2109. Communication network 2109 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 2109) may separately or together include one or more communications paths, such as, for example, a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 21 to avoid overcomplicating the drawing.

Although communications paths are not drawn between user equipment, these devices may communicate directly with each other via communications paths as well as other short-range, point-to-point communications paths, such as, for example, USB cables, IEEE 1394 cables, wireless paths (e.g., Bluetooth, infrared, IEEE 702-11x, etc.), or other short-range communication via wired or wireless paths. The user equipment may also communicate with each other directly through an indirect path via communication network 2109.

System 2100 may comprise media content source 2102, one or more servers 2104, and/or one or more edge computing devices. In some embodiments, the application may be executed at one or more of control circuitry 2111 of server 2104 (and/or control circuitry of user equipment 2106, 2107, 2108, 2110 and/or control circuitry of one or more edge computing devices). The application may be the XR application described in FIG. 1. In some embodiments, the media content source and/or server 2104 may be configured to host or otherwise facilitate video communication sessions between user equipment 2106, 2107, 2108, 2110 and/or any other suitable user equipment, and/or host or otherwise be in communication (e.g., over communication network 2109) any other suitable service or platform.

In some embodiments, server 2104 may include control circuitry 2111 and storage 2114 (e.g., RAM, ROM, hard disk, removable disk, etc.). Storage 2114 may store one or more databases. Server 2104 may also include an I/O path 2008. In some embodiments, I/O path 2008 is an I/O circuitry. I/O circuitry may be a NIC card, audio output device, mouse, keyboard card, any other suitable I/O circuitry device or combination thereof. I/O path 2008 may provide video conferencing data, device information, or other data, over a local area network (LAN) or wide area network (WAN), and/or other content and data to control circuitry 2111, which may include processing circuitry, and storage 2114. Control circuitry 2111 may be used to send and receive commands, requests, and other suitable data using I/O path 2008, which may comprise I/O circuitry. I/O path 2008 may connect control circuitry 2111 to one or more communications paths.

Control circuitry 2111 may be based on any suitable control circuitry such as, for example, one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, control circuitry 2111 may be distributed across multiple separate processors or processing units, for example, multiple of the same type of processing units (e.g., two Intel Core i7 processors) or multiple different processors (e.g., an Intel Core i6 processor and an Intel Core i7 processor). In some embodiments, control circuitry 2111 executes instructions for an emulation system application stored in memory (e.g., the storage 2114). Memory may be an electronic storage device provided as storage 2114 that is part of control circuitry 2111. Memory may store instruction to run the application.

1. An extended reality (XR) apparatus comprising:
a wide-angle camera;
a telephoto camera;
control circuitry configured to:
cause the wide-angle camera to capture a wide-angle view of an environment;
determine a region of interest (ROI) in the wide-angle view, wherein the ROI comprises an object;
cause the telephoto camera to capture a zoomed-in view of the ROI;
generate a disparity map based at least in part on a difference between a location of the object in the wide-angle view and a location of the object in the zoomed-in view;
based at least in part on the disparity map, process the wide-angle view and the zoomed-in view to correlate the location of the object in the wide-angle view with the location of the object in the zoomed-in view; and
cause the XR apparatus to display the processed zoomed-in view overlaid on the processed wide-angle view.

2. The XR apparatus of claim 1, wherein the control circuitry is further configured to process the zoomed-in view by adjusting a zoom level of the telephoto camera, wherein the disparity map is updated based at least in part on the adjusted zoom level.

3. The XR apparatus of claim 2, wherein the XR apparatus comprises a first telephoto camera and a second telephoto camera configured to capture a first zoomed-in view and a second zoomed-in view, respectively, and the control circuitry is configured to adjust the zoom level of the telephoto camera by equalizing an apparent size of the object in the first zoomed-in view and the second zoomed-in view and causing the apparent size to remain within a predefined range.

4. The XR apparatus of claim 1, wherein the control circuitry is further configured to process the zoomed-in view by adjusting a position of the telephoto camera.

5. The XR apparatus of claim 1, wherein the control circuitry is further configured to process the zoomed-in view by recalibrating the telephoto camera based at least in part on a detected motion or a predicted motion of a user associated with the XR apparatus.

6. The XR apparatus of claim 1, wherein the control circuitry is further configured to:
determine a change in the ROI to a new ROI;
update the disparity map based at least in part on the new ROI;
further process the zoomed-in view and the wide-angle view based at least in part on the updated disparity map; and
cause display of the further processed zoomed-in view and the wide-angle view.

7. The XR apparatus of claim 1, wherein the control circuitry is further configured to determine the ROI by:
determining a gaze vector corresponding to a gaze of a user of the XR apparatus; and
determining that the gaze vector intersects coordinates of the object.

8. The XR apparatus of claim 1, wherein the control circuitry is further configured to:
determine that the object is in motion;
predict a future path of the motion of the object; and
cause the telephoto camera to capture the zoomed-view based at least in part by continuously tracking the object based at least in part on the predicted future path.

9. The XR apparatus of claim 1, wherein the processed zoomed-in view is overlaid on the processed wide-angle view at a location corresponding to the ROI.

10. The XR apparatus of claim 1, wherein the processed zoomed-in view is overlaid on the processed wide-angle view at a location that is different from the ROI.

11. The XR apparatus of claim 1, wherein the disparity map is a first disparity map, and the telephoto camera comprises:
a left telephoto camera; and
a right telephoto camera, and wherein the control circuitry is further configured to:
generate a second disparity map based at least in part on zoomed-in views captured by the left telephoto camera and the right telephoto camera; and
update the first disparity map with the second disparity map.

12. The XR apparatus of claim 1, wherein an inertial measurement unit (IMU) that detects motion of the XR apparatus further comprises control circuitry to pause display of the zoomed in view by:
detecting motion of the XR apparatus;
based at least in part on determining that motion of the XR apparatus is above a threshold, causing the pausing of the display of the zoomed-in view.

13. A method comprising:
causing a wide-angle camera of an extended reality (XR) apparatus to capture a wide-angle view of an environment;
determining a region of interest (ROI) in the wide-angle view, wherein the ROI comprises an object;
causing a telephoto camera of the XR apparatus to capture a zoomed-in view of the ROI;
generating a disparity map based at least in part on a difference between a location of the object in the wide-angle view and a location of the object in the zoomed-in view;
based at least in part on the disparity map, processing the wide-angle view and the zoomed-in view to correlate the location of the object in the wide-angle view with the location of the object in the zoomed-in view; and
causing the XR apparatus to display the processed zoomed-in view overlaid on the processed wide-angle view.

14. The method of claim 13, wherein adjusting a zoom level of the telephoto camera causes the disparity map to update based at least in part on the adjusted zoom level.

15. The method of claim 14, wherein the XR apparatus comprises a first telephoto camera and a second telephoto camera configured to capture a first zoomed-in view and a second zoomed-in view, respectively, and adjusting the zoom level of the telephoto camera comprises equalizing an apparent size of the object in the first zoomed-in view and the second zoomed-in view and causing the apparent size to remain within a predefined range.

16. The method of claim 13, further comprising:
adjusting a position of the telephoto camera based at least in part on the zoomed-in view.

17. The method of claim 13, further comprising:
processing the zoomed-in view by recalibrating the telephoto camera based at least in part on a detected motion or a predicted motion of a user associated with the XR apparatus.

18. The method of claim 13, further comprising:
determining a change in the ROI to a new ROI;
updating the disparity map based at least in part on the new ROI;
processing the zoomed-in view and the wide-angle view based at least in part on the updated disparity map; and
causing display of the further processed zoomed-in view and the wide-angle view.

19. The method of claim 13, further comprising:
determining the ROI by determining a gaze vector corresponding to a gaze of a user of the XR apparatus and by determining that the gaze vector intersects coordinates of the object.

20. The method of claim 13, further comprising:
determining that the object is in motion;
predicting a future path of the motion of the object; and
causing the telephoto camera to capture the zoomed-view based at least in part by continuously tracking the object based at least in part on the predicted future path.

21-132. (canceled)
